(19) United States
(12) Patent Application Publication
(10) Pub. No.: US 2025/0294443 A1
(43) Pub. Date: Sep. 18, 2025

(54) CELL SELECTION IN NON-TERRESTRIAL NETWORKS

(71) Applicant: TELEFONAKTIEBOLAGET LM ERICSSON (PUBL), Stockholm (SE)

(72) Inventors: Ming Li, STOCKHOLM (SE); Muhammad Ali Kazmi, RESTON, VA (US); Zhixun Tang, Beijing (CN)

(21) Appl. No.: 18/859,630

(22) PCT Filed: Apr. 24, 2023
(86) PCT No.: PCT/IB2023/054201

§ 371 Date: Oct. 24, 2024

(30) Foreign Application Priority Data
Apr. 25, 2022 (WO) PCT/CN2022/089027
May 12, 2022 (WO) PCT/CN2022/092552

(51) Int. Cl. H04W 48/20; H04W 64/00; H04W 84/04; H04W 84/06

(52) U.S. Cl. CPC H04W 48/20; H04W 64/00; H04W 84/042; H04W 84/06

(57) ABSTRACT

A method (100′) in a terminal node for performing a cell selection procedure in a NTN system. The method (100′) includes: in response to receiving (s110′) at least one NTN parameter defining a time and/or location relationship between the terminal node and a serving cell, initiating (s120′) a cell selection procedure to find a cell meeting a cell selection criterion after a time period.

### TECHNICAL FIELD

The present disclosure relates to wireless communication in a non-terrestrial network system, and more particularly, to terminal nodes, network nodes, and methods therein for facilitating terminal node's cell selection procedure in a non-terrestrial network system.

### BACKGROUND

### Non-Terrestrial Network (NTN)

There is an ongoing resurgence of satellite communications. Several plans for satellite networks have been announced in the past few years. Satellite networks complement mobile networks on the ground by providing connectivity to underserved areas and multicast/broadcast services.

To benefit from the strong mobile ecosystem and economies of scale, adapting the terrestrial wireless access technologies, including Long Term Evolution (LTE) and New Radio (NR), for satellite networks is drawing significant interest, which has been reflected in the Third Generation Partnership Project (3GPP) standardization work.

In 3GPP Release 15, the first release of the 5G system (5GS) was specified. This is a new generation's radio access technology intended to serve use cases such as enhanced mobile broadband (eMBB), ultra-reliable and low latency communication (URLLC), and mMTC. 5G includes the New Radio (NR) access stratum interface and the 5G Core Network (5GC). The NR physical and higher layers are reusing parts of the LTE specification, and to that add needed components when motivated by new use cases. One such component is the introduction of a sophisticated framework for beam forming and beam management to extend the support of the 3GPP technologies to a frequency range going beyond 6 GHz.

In Release 15, 3GPP started the work to prepare NR for operation in a non-terrestrial network (NTN). The work was performed within the study item “NR to support non-terrestrial networks” and resulted in 3GPP TR 38.811. In Release 16 of 3GPP TR 38.821, the work to prepare NR for operation in an NTN network continued with the study item “Solutions for NR to support Non-terrestrial network”. In parallel the interest to adapt NB-IoT and LTE-M for operation in NTN is growing. As a consequence, 3GPP Release 17 contains both a work item on NR NTN and a study item on NB-IoT and LTE-M support for NTN.

A satellite radio access network usually includes the following components: a satellite that refers to a space-borne platform; an earth-based gateway that connects the satellite to a base station or a core network, depending on the choice of architecture, a feeder link that refers to the link between a gateway and a satellite, and an access link, or service link, that refers to the link between a satellite and a UE.

Depending on the orbit altitude, a satellite may be categorized as low earth orbit

(LEO) (typical heights ranging from 250-1,500 km, with orbital periods ranging from 90-120 minutes), medium earth orbit (MEO) (typical heights ranging from 5,000-25,000 km, with orbital periods ranging from 3-15 hours), or geostationary earth orbit (GEO) satellite (height at about 35,786 km, with an orbital period of 24 hours).

Two basic architectures can be distinguished for satellite communication networks, depending on the functionality of the satellites in the system: (1) transparent payload (also referred to as bent pipe architecture) and (2) regenerative payload.

In the transparent payload architecture, the satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE.

In the regenerative payload architecture, the satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP release 17, only the transparent payload architecture is considered.

A satellite network or satellite based mobile network may also be called as non-terrestrial network (NTN). On the other hand mobile network with base stations on the group may also be called as terrestrial network (TN) or non-NTN network. A satellite within NTN may be called as NTN node, NTN satellite or simply a satellite.

FIG. 1 shows an exemplary architecture of a satellite network with bent pipe transponders (i.e. the transparent payload architecture). The satellite communicates with the gateway via a feeder link, and communicates with the device via an access link by forming a spotbeam covering the device. The gNB may be integrated in the gateway or connected to the gateway via a terrestrial connection (e.g., wire, optical fiber, wireless link). The satellite forwards signals/data between the gNB and the device.

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion (where the latter may be referred to as quasi-earth-fixed beams or quasi-earth-fixed cells). The size of a spotbeam depends on the system design, which may range from tens of kilometers to a few thousands of kilometers.

In a LEO or MEO communication system, a large number of satellites deployed over a range of orbits are required to provide continuous coverage across the full globe.

Launching a mega satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

### NB-IoT Operation

Narrow Band Internet of Things (NB-IoT) addresses improved indoor coverage, support for massive number of low throughput devices, low delay sensitivity, ultra-low device cost, low device power consumption and (optimized) network architecture. The NB-IoT carrier BW (Bw2) is 200 KHz.

NB-IoT supports 3 different deployment scenarios or mode of operations, as described below.

(1) ‘Stand-alone operation’ utilizing for example the spectrum currently being used by GERAN systems as a replacement of one or more GSM carriers. In principle it operates on any carrier frequency which is neither within the carrier of another system nor within the guard band of another system's operating carrier. The other system can be another NB-IoT operation or any other RAT e.g. LTE.

(2) ‘Guard band operation’ utilizing the unused resource blocks within an LTE carrier's guard-band. The term guard band may also interchangeably called as guard bandwidth. As an example in case of LTE BW of 20 MHz (i.e. Bw1=20 MHz or 100 RBs), the guard band operation of NB-IoT can place anywhere outside the central 18 MHz but within 20 MHz LTE BW.

(3) ‘In-band operation’ utilizing resource blocks within a normal LTE carrier. The in-band operation may also interchangeably be called in-bandwidth operation. More generally the operation of one RAT within the BW of another RAT is also called as in-band operation. As an example in a LTE BW of 50 RBs (i.e. Bw1=10 MHz or 50 RBs), NB-IoT operation over one resource block (RB) within the 50 RBs is called in-band operation.

In NB-IoT anchor and non-anchor carriers are defined. In anchor carrier the UE assumes that anchor specific signals including NPSS/NSSS/NPBCH/SIB-NB are transmitted on downlink. In non-anchor carrier the UE does not assume that NPSS/NSSS/NPBCH/SIB-NB are transmitted on downlink. The anchor carrier is transmitted on at least subframes #0, #4, #5 in every frame and subframe #9 in every other frame

### UE Measurements

The UE performs measurements on one or more DL and/or UL reference signal (RS) of one or more cells in different UE activity states e.g. RRC idle state, RRC inactive state, RRC connected state etc. The measured cell may belong to or operate on the same carrier frequency as of the serving cell (e.g. intra-frequency carrier) or it may belong to or operate on different carrier frequency as of the serving cell (e.g. non-serving carrier frequency). The non-serving carrier may be called as inter-frequency carrier if the serving and measured cells belong to the same RAT bit different carriers. The non-serving carrier may be called as inter-RAT carrier if the serving and measured cells belong to different RATs. Examples of downlink RS are signals in SSB, CSI-RS, CRS, DMRS, PSS, SSS, signals in SS/PBCH block (SSB), discovery reference signal (DRS), PRS, NSSS, NPSS, NRS etc. Examples of uplink RS are signals in SRS, DMRS etc.

Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms.

Examples of measurements are cell identification (e.g. PCI acquisition, PSS/SSS detection, cell detection, cell search etc), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), narrowband RSRP (NRSRP), narrowband RSRQ (NRSRQ), acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection etc.

The UE is typically configured by the network (e.g. via RRC message) with measurement configuration and measurement reporting configuration e.g. measurement gap pattern, carrier frequency information, types of measurements (e.g. RSRP etc), higher layer filtering coefficient, time to trigger report, reporting mechanism (e.g. periodic, event triggered reporting, event triggered periodic reporting etc) etc.

The measurements are done for various purposes. Some example measurement purposes are: UE mobility (e.g. cell change, cell selection, cell reselection, handover, RRC connection re-establishment etc), UE positioning or location determination self-organizing network (SON), minimization of drive tests (MDT), operation and maintenance (O&M), network planning and optimization etc.

### Serving Cell Measurement and Evaluation

The UE measurement rules for measurements on serving cell in RRC idle/inactive states for legacy UE in NR are defined in 3GPP TS 38.133 v17.5.0.

According to rules the UE shall measure the SS-RSRP and SS-RSRQ level of the serving cell and evaluate the cell selection criterion S defined in 3GPP TS 38.304 v17.0.0 for the serving cell at least once every M1*N1 DRX cycle; where: M1=2 if SMTC periodicity (TSMTC)>20 ms and DRX cycle≤0.64 second, otherwise M1=1.

The UE shall filter the SS-RSRP and SS-RSRQ measurements of the serving cell using at least 2 measurements. Within the set of measurements used for the filtering, at least two measurements shall be spaced by, at least DRX cycle/2.

If the UE has evaluated according to Table 1 in Nₛₑᵣᵥ consecutive DRX cycles that the serving cell does not fulfil the cell selection criterion S, the UE shall initiate the measurements of all neighbour cells indicated by the serving cell, regardless of the measurement rules currently limiting UE measurement activities. The cell selection criterion S for a cell is evaluated by comparing the Srxlev and Squal of that with their respective thresholds. The Srxlev and Squal for a cell are derived or determined by the UE based on at least SS-RSRP and SS-RSRQ measurements respectively performed by the UE on that cell. In one example, the cell selection criterion S for a cell is fulfilled when the following condition is met otherwise the cell selection criterion S for that cell is not fulfilled: Srxlev>0 AND Squal>0.

Srxlev is defined as: Srxlev=Qᵣₓₗₑᵥₘₑₐₛ−(Qᵣₓₗₑᵥₘₑₐₛ+Q_{rxlevminoffset})−P_{compensation}−Qoffsetₜₑₘₚ, where Srxlev is the cell selection received (RX) level value (dB), Qᵣₓₗₑᵥₘₑₐₛ is the measured cell RX level value (RSRP), Qᵣₓₗₑᵥₘᵢₙ is the minimum required RX level in the cell (dBm). It is signalled by the cell, Q_{rxlevminoffset} is the offset to the signalled Qᵣₓₗₑᵥₘᵢₙ. It is signalled by the cell, and Qoffsetₜₑₘₚ: It is the offset temporarily applied to a cell. It is signalled by the cell.

Squal is defined as follows: Squal=Q_{qualmeas}−(Q_{qualmin}+Q_{qualminoffset})−Qoffsetₜₑₘₚ, where Squal is the cell selection quality value (dB), Q_{qualmeas} is the measured cell quality level value (RSRQ), is the minimum required quality level in the cell (dB). It is signalled by the cell, and Q_{qualminoffset} is the offset to the signalled Q_{qualmin}. It is also signalled by the cell.

If the UE in RRC_IDLE has not found any new suitable cell based on searches and measurements using the intra-frequency, inter-frequency and inter-RAT information indicated in the system information for 10 s, the UE shall initiate cell selection procedures for the selected PLMN as defined in TS 38.304 v17.0.0.

TABLE 1
Nₛₑᵣᵥ

| | | |
|---|---|---|
| | Scaling | Nₛₑᵣᵥ |
| DRX cycle | Factor (N1) | [number of |

| length [s] | FR1 | FR2^{Note1} | DRX cycles] |
|---|---|---|---|
| 0.32 | 1 | 8 | M1*N1*4 |
| 0.64 | | 5 | M1*N1*4 |
| 1.28 | | 4 | N1*2 |
| 2.56 | | 3 | N1*2 |

^{Note1}:
Applies for UE supporting power class 2&3&4. For UE supporting power class 1, N1 = 8 for all DRX cycle length.

Examples of cell selection procedures for the selected PLMN are: (1) UE scan all RF channels in the NR bands according to its capabilities to find or detect a suitable cell and (2) UE using stored information of frequencies and optionally also information on cell parameters from previously received measurement control information elements or from previously detected cells for selecting a cell.

The UE measurement rules for measurements on serving cell in RRC idle/inactive states for legacy UE in LTE are defined in 3GPP TS 38.133 v17.5.0. According the rules LTE UE (including MTC UE e.g. UE category M1 or M2) shall perform the measurements as following:

“If the UE in RRC_IDLE has not found any new suitable cell based on searches and measurements using the intra-frequency, inter-frequency and inter-RAT information indicated in the system information during the time T, the UE shall initiate cell selection procedures for the selected PLMN. The value of T may be different for MTC UE and NB-IoT UEs.

For MTC capable UE (e.g. UE category M1 or M2), T=10 s if the UE is not configured with eDRX_IDLE cycle, and T=MAX(10 s, one eDRX_IDLE cycle) if the UE is configured with eDRX_IDLE cycle.

For NB-IoT capable UE (e.g. UE category NB1 or NB2), T=40 s if the UE is not configured with eDRX_IDLE cycle, and T=MAX(40 s, one eDRX_IDLE cycle) if the UE is configured with eDRX_IDLE cycle.”

### Measurement Rules for NTN in RRC Idle/Inactive State

A UE served by NTN node (e.g. satellite node) applies one or more existing measurement rules defined for legacy UE (i.e. UE served by terrestrial network). However, the NTN capable UE is also required to perform measurements according to additional rules which are specific to operation in NTN i.e. UE served by the NTN node.

According to 3GPP TS 38.304 v17.0.0, if a parameter, “t-Service” of the serving cell is present in system information (e.g. in a SIB) then the UE should start to perform intra-frequency, inter-frequency or inter-RAT measurements before the t-Service, regardless of the distance between UE and the serving cell reference location or whether the serving cell fulfills Srxlev>SIntraSearchP and Squal>SIntraSearchQ, or Srxlev>SnonIntraSearchP and Squal>SnonIntraSearchQ and the exact time to start measurement before t-Service is up to UE implementation. The UE shall perform measurements of higher priority NR inter-frequency or inter-RAT frequencies regardless of the remaining service time of the serving cell. “t-Service” is broadcasted in the SI and is expressed in UTC e.g. in number of UTC seconds in 10 ms units. SIntraSearchP specifies the Srxlev threshold (in dB) for intra-frequency measurements. SIntraSearchQ specifies the Squal threshold (in dB) for intra-frequency measurements. SnonIntraSearchP specifies the Srxlev threshold (in dB) for NR inter-frequency and inter-RAT measurements. SnonIntraSearchQ specifies the Squal threshold (in dB) for NR inter-frequency and inter-RAT measurements.

According to 3GPP TS 38.304 v17.0.0, if a parameter, “distanceThresh” is broadcasted in system information (e.g. in a SIB), and if UE supports location-based measurement initiation and has valid UE location information, and the distance between UE and the serving cell reference location is shorter than distanceThresh, then the UE may choose not to perform measurements on any of intra-frequency cells, NR inter-frequency cells of equal or lower priority or inter-RAT frequency cells of lower priority. Otherwise the UE performs measurements on intra-frequency cells, NR inter-frequency cells of equal or lower priority or inter-RAT frequency cells of lower priority. “distanceThresh” is broadcasted in the SI and is expressed in meters e.g. in multiple of 50 m.

eDRX Cycle Operation

In NR, the enhanced DRX (eDRX) cycle is being specified for UE in RRC_IDLE and RRC_INACTIVE. The purpose of eDRX cycle is further enable UE power saving even more than achieved by the UE when configured only with DRX cycle. The eDRX ranges between few seconds to several minutes or even hours. In one example eDRX cycle may range from 5.12 seconds (shortest eDRX) up to 10485.76 s (largest eDRX). eDRX cycle may also be multiple of 1.28 second which is typical DRX cycle used in idle and inactive states.

eDRX configuration parameters are negotiated between UE and the network via higher layer signaling e.g. via non-access stratum (NAS) messages. During the negotiation the network transmits eDRX parameters, which may comprise eDRX cycle length; paging time window (PTW), hyper system frame number (H-SFN), paging H-SFN (PH) etc.

H-SFN comprise of multiple SFN cycles as shown in FIG. 2. FIG. 2 illustrates a structure of an H-SFN cycle. A SFN cycle is a counter which initializes after certain number of frames. In one example SFN cycle comprising of 1024 frames i.e. varies from 0 to 1023. H-SFN is a frame structure on top of the legacy SFN structure, where each H-SFN value corresponds to a cycle of legacy frames (e.g. 1024 frames) and one H-SFN cycle contains X1 number of SFN cycles e.g. X1=1024. The network (e.g. core NW such as MMEs, BS, gNodeBs etc) have the same H-SFN, and cells broadcast their H-SFN via system information e.g. SIB. The boundaries of the eDRX acquisition period are determined by H-SFN values for which H-SFN mod X1=0 e.g. X1=256.

The UE is configured with PTW by the NW (e.g. by MME) via NAS during e.g. attach/tracking area update. The beginning of PTW is calculated by a pre-defined formula (as described below). Within a PTW, the UE is further configured with a legacy DRX as shown in FIG. 3. FIG. 3 illustrates the relation between H-SFN, paging time window (PTW) and eDRX periodicity.

In one example PTW is characterized by or determined by the UE using the following mechanism:
Paging H-SFN (PH) (calculated by a formula): H-SFN mod T_{eDRX}=(UE_ID mod T_{eDRX}), UE_ID: IMSI mod X2 e.g. X2=1024; T_{eDRX}: eDRX cycle length of the UE, (T_{eDRX}=1, 2, . . . , X3 in hyper-frames) and configured by upper layers e.g. X3=256;
PTW start is calculated within PH as follows: The start of PTW is uniformly distributed across X4 (e.g. X4=4) paging starting points within the PH. PTW_start denotes the first radio frame of the PH that is part the paging window and has SFN satisfying the following equation: SFN=X3*ieDRX, where ieDRX=floor (UE_ID/T_{eDRX},H) mod X4. PTW_end is the last radio frame of the PTW and has SFN satisfying the following equation: SFN=(PW_start+L*X5−X6) mod X2, e.g. X5=100, X6=1, where: L=Paging Window length (in seconds) configured by upper layers e.g. via RRC;
PTW length (configured by higher layers).

The UE initiates cell selection procedures for the selected PLMN, if the UE in RRC_IDLE does not find any new suitable cell based on searches and measurements using the intra-frequency, inter-frequency and inter-RAT information indicated in the system information for 10 s.

However, UE in NTN, in additional to existing cell reselection procedures based on legacy RSRP/RSRQ measurements, two kinds of assistance information are introduced to facilitate reselection in various NTN scenarios.

Regarding Time-Based Cell Reselection, there are Agreements in RAN2:

“In quasi-earth fixed case (no moving case), the timing information, broadcast to UE via system information, on when a cell is going to stop serving the area is used to decide when to perform measurement to assist cell reselection.

quasi-earth fixed cell, UE should start measurements on neighbour cells before the serving cell stops covering the current area.

For quasi-earth fixed cell, the broadcast “timing information on when a cell is going to stop serving the area” refers to the time when a cell stops covering the current area.

For quasi-earth fixed cell, specify that UE should start measurements on neighbour cells before the broadcast stop time of the serving cell, i.e. the time when the serving cell stops covering the current area, and the exact time to start measurements is up to UE implementation.”

T_{service} (same as “t-service” herein) indicates the time information on when a cell provided via NTN quasi-Earth fixed system is going to stop serving the area it is currently covering. It is broadcasted by network e.g. by the serving cell via system information.

### Regarding Location-Based Cell Reselection, the Agreements in RAN2 are Listed:

“For quasi-earth fixed cell, same as legacy, UE shall perform neighbour cell measurements of “higher priority NR inter-frequency or inter-RAT frequencies” regardless of the distance between UE and serving cell reference location.

For quasi-earth fixed cell, UE should start measurements on neighbour cells before the serving cell stops covering the current area, regardless of (the distance between UE and serving cell reference location) or (if legacy Srxlev/Squal condition is met, i.e., serving cell's Srxlev/Squal is better than a threshold).

UE may choose not to perform neighbour cell measurements of “NR intra-freq or inter-freq with equal or lower priority, or inter-RAT frequency with lower priority”, if (the distance between UE and serving cell reference location is shorter than a threshold) and (legacy Srxlev/Squal condition is met, i.e., serving cell's Srxlev/Squal is better than a threshold).

Location-based measurement initiation is only applied if the cell broadcasts location-related parameters (e.g. a threshold) and by implementation the UE has location information.”

D_{distanceThresh} (same as “distanceThresh” herein) indicates the threshold of distance between UE and serving cell reference location. D_{distanceThresh} and the reference location are broadcasted by network e.g. by the serving cell via system information.

The impact of the NTN specific parameters, such as T_{service}, related to measurements in idle/inactive state on cell selection procedure when serving cell does not meet the cell selection criterion is by far undefined and unknown. The lack of the UE behaviour may lead to either premature cell selection or it may delay the cell selection. In either case the mobility performance is degraded or it may even fail.

### SUMMARY

It is an object of the present disclosure to provide terminal nodes, network nodes, and methods therein, to facilitate the terminal node's cell selection.

According to a first aspect of the present disclosure, a method at a terminal node for performing a cell selection procedure in a NTN system is provided. In one embodiment, the method includes determining whether a serving cell meets a cell selection criterion at time instance T1. The method also includes, in response to determining that a serving cell does not meet a cell selection criterion at time instance T1, determining a time period after which the terminal node initiates a cell selection procedure to find a cell meeting the cell selection criterion. The determination of the time period is at least partially based on at least a first obtained parameter and one or more NTN parameters defining a time and/or location relationship between the terminal node and the serving cell.

In an exemplary embodiment, the time period starts from the time instance T1.

In an exemplary embodiment, the obtained parameter is pre-defined or received from a network node.

In an exemplary embodiment, the NTN parameter comprises at least one of a service time parameter that indicates the time when the serving cell is going to stop serving an area it is currently covering and a location parameter that indicates a distance threshold between the terminal node and a reference location of the serving cell.

In an exemplary embodiment, the at least one obtained parameter comprises a time threshold, and the time period is the lower one of the time threshold and the service time parameter.

In an exemplary embodiment, the time period is equal to the obtained parameter, if the service time parameter is larger than the sum of T1 and the obtained parameter.

In an exemplary embodiment, the time period is equal to a magnitude of a difference between the service time parameter and T1, if the service time parameter is less than the sum of T1 and the obtained parameter.

In an exemplary embodiment, the at least one obtained parameter comprises a time threshold, and the time period is the lower one of the time threshold and a time instance T2 when a distance between the terminal node and the reference location of the service cell becomes equal to or larger than the distance threshold defined by the location parameter.

In an exemplary embodiment, the time period is equal to the obtained parameter, if a time instance T2 is larger than or equal to the sum of T1 and the obtained parameter, where T2 is the time when a distance between the terminal node and the reference location of the service cell becomes equal to or larger than the distance threshold defined by the location parameter.

In an exemplary embodiment, the time period is equal to a magnitude of a difference between a time instance T2 and T1, if T2 is less than the sum of T1 and the obtained parameter, where T2 is the time when a distance between the terminal node and the reference location of the service cell becomes equal to or larger than the distance threshold defined by the location parameter.

In an exemplary embodiment, the time threshold is a time length of 10 seconds.

In an exemplary embodiment, the at least one obtained parameter comprises a time threshold, and the time period is zero if the service time parameter is lower than the time threshold.

In an exemplary embodiment, the at least one obtained parameter comprises a time threshold, and the time period is zero if a time instance T2 is lower than the time threshold, where T2 is the time when a distance between the terminal node and the reference location of the service cell becomes equal to or larger than the distance threshold defined by the location parameter.

In an exemplary embodiment, the terminal node is further provided with a DRX cycle, and the time period is determined further based on a DRX cycle length.

In an exemplary embodiment, the terminal node is further provided with an eDRX cycle, and the time period is determined further based on an eDRX cycle length.

In an exemplary embodiment, the time period is determined further based on a type of NTN node of the NTN system.

In an exemplary embodiment, the method may further include: initiating a cell selection procedure for a selected Public Land Mobile Network, PLMN, if no cell is found during the determined time period; or initiating a cell selection procedure for a selected PLMN immediately after T1 if the time period is determined to be zero.

In an exemplary embodiment, the terminal node operates in a low activity RRC state, comprising RRC IDLE mode or RRC INACTIVITE mode.

According to a second aspect of the present disclosure, a method at a terminal node for performing a cell selection procedure in a NTN system is provided. In one embodiment, the method includes receiving at least one NTN parameter defining a time and/or location relationship between the terminal node and a serving cell. The method also includes, in response to receiving the at least one NTN parameter, initiating a cell selection procedure to find a cell meeting a cell selection criterion after a time period.

In an exemplary embodiment, the NTN parameter comprises at least one of a service time parameter that indicates the time when the serving cell is going to stop serving an area it is currently covering and a location parameter that indicates a distance threshold between the terminal node and a reference location of the serving cell.

In an exemplary embodiment, the time period starts from the time instance defined by the service time parameter.

In an exemplary embodiment, the time period starts from the time when a distance between the terminal node and the reference location of the service cell becomes equal to or larger than the distance threshold defined by the location parameter.

In an exemplary embodiment, the time period is a time of 10 seconds.

According to a third aspect of the present disclosure, a terminal node is provided. The terminal node may include a communication interface, a processor and a memory. The memory contains instructions executable by the processor whereby the terminal node is operative to perform the method according to the above first and second aspects.

According to a fourth aspect of the present disclosure, a computer readable storage medium is provided. The computer readable storage medium has computer program instructions stored thereon. The computer program instructions, when executed by a processor in a terminal node, cause the terminal node to perform the method according to the above first and second aspects.

According to a fifth aspect of the present disclosure, a method in a network node for configuring a terminal node in a NTN system is provided. In one embodiment, the method includes transmitting, to the terminal node, at least one NTN parameter defining a time and/or location relationship between the terminal node and a serving cell and at least one additional parameter, the additional parameter and the NTN parameter being used by the terminal node in determining a time period after which the terminal node initiates a cell selection procedure to find a cell meeting a cell selection criterion, after determining that the serving cell does not meet the cell selection criterion.

In an exemplary embodiment, the NTN parameter comprises at least one of a service time parameter that indicates the time when the serving cell is going to stop serving an area it is currently covering and a location parameter that indicates a distance threshold between the terminal node and a reference location of the serving cell.

In an exemplary embodiment, the at least one additional parameter comprises a time threshold after which the terminal node initiates the cell selection procedure.

In an exemplary embodiment, the at least one additional parameter comprises a rule defining a way to consider a DRX cycle length or an eDRX cycle length in determining the time period.

According to a sixth aspect of the present disclosure, a network node is provided. The network node may include a communication interface, a processor and a memory. The memory contains instructions executable by the processor whereby the network node is operative to perform the method according to the above fifth aspect.

According to a seventh aspect of the present disclosure, a computer readable storage medium is provided. The computer readable storage medium has computer program instructions stored thereon. The computer program instructions, when executed by a processor in a network node, cause the network node to perform the method according to the above fifth aspect.

With the embodiments of the present disclosure, a clear UE measurement behavior in a NTN system is proposed. The proposed UE measurement behavior may improve

UE idle state mobility, and also support more flexible configurations by the network.

### BRIEF DESCRIPTION OF THE DRAWINGS

The above and other objects, features and advantages will be more apparent from the following description of embodiments with reference to the figures, in which:

FIG. 1 shows an exemplary architecture of a satellite network with bent pipe transponders;

FIG. 2 illustrates a structure of an H-SFN cycle;

FIG. 3 illustrates the relation between H-SFN, paging time window (PTW) and eDRX periodicity;

FIG. 4A is a flowchart illustrating a method in a terminal node according to an exemplary embodiment of the present disclosure;

FIG. 4B is a flowchart illustrating a method in a terminal node according to another exemplary embodiment of the present disclosure;

FIG. 5 is a flowchart illustrating a method in a network node according to an exemplary embodiment of the present disclosure;

FIG. 6 a timing relation between T_{fails} and T_{service} when they are far apart in time;

FIG. 7 illustrates a timing relation between T_{fails} and T_{service} when they are closer in time;

FIG. 8A illustrates a timing relation between T_{fails} and T_{service} when they are within a threshold;

FIG. 8B illustrates a timing relation between T_{fails} and T_{service} when T_{service} arrives before T_{fails};

FIG. 9 is a block diagram of a terminal node according to an exemplary embodiment of the present disclosure;

FIG. 10 is a block diagram of a terminal node according to another embodiment of the present disclosure;

FIG. 11 is a block diagram of a network node according to an exemplary embodiment of the present disclosure;

FIG. 12 is a block diagram of a network node according to another embodiment of the present disclosure;

FIG. 13 schematically illustrates a telecommunication network connected via an intermediate network to a host computer;

FIG. 14 is a generalized block diagram of a host computer communicating via a base station with a user equipment over a partially wireless connection;

FIGS. 15 to 18 are flowcharts illustrating methods implemented in a communication system including a host computer, a base station and a user equipment.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein;

rather, these embodiments are provided by way of example to convey the scope of the subject matter to those skilled in the art. Additional information may also be found in references as follows: (1) 3GPP TS 38.133, V17.5.0 (2022 March), (2) 3GPP TS 38.304, V17.0.0 (2022 March) (3) 3GPP TR 38.311, V15.4.0 (2020 September), and (4) 3GPP TR 38.821, V16.0.0 (2019 December).

As used herein, the term “satellite” is often used even when a more appropriate term would be “gNB associated with the satellite”. The term “satellite” may also be called as a satellite node, a NTN node, node in the space etc. Here, gNB associated with a satellite might include both a regenerative satellite, where the gNB is the satellite payload, i.e. the gNB is integrated with the satellite, or a transparent satellite, where the satellite payload is a relay and gNB is on the ground (i.e. the satellite relays the communication between the gNB on the ground and the UE).

Time period or duration over which a UE can maintain connection, or can camp on, or can maintain communication, and so on to a satellite or a gNB by UE is referred to as term “coverage time” or “serving time” or “network availability” or “sojourn time” or “dwell time”, etc. The term ‘Non-coverage time’, also known as “non-serving time” or “network unavailability”, or “non-sojourn time” or “non-dwell time” refers to a period of time during which a satellite or gNB cannot serve or communicate or provide coverage to a UE. Another way to interpret the availability is that is not about a satellite/network strictly not able to serve the UE due to lack of coverage but that UE does not need to measure certain “not likely to be serving cell (satellite via which serving cell is broadcasted)”. In this case, the terminology may still be as in no coverage case or it may be different, e.g. “no need to measure”.

The term node is used which can be a network node or a user equipment (UE).

Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O&M, OSS, SON, positioning node (e.g. E-SMLC), satellite access node (SAN) etc.

The term “terminal node” refers to any end device that can access a wireless communication network and receive services therefrom. By way of example and not limitation, the terminal node refers to a mobile terminal, user equipment (UE), or other suitable devices.

The non-limiting term UE refers to any type of wireless device communicating with a network node and/or with another UE in a cellular or mobile communication system. Examples of UE are target device, device to device (D2D) UE, vehicular to vehicular (V2V), machine type UE, machine type communication (MTC) capable UE or UE capable of machine to machine (M2M) communication, PDA, tablet, mobile terminals, smart phone, laptop embedded equipment (LEE), laptop mounted equipment (LME), USB dongles etc. Examples of MTC or M2M capable UE are UE category 0, UE category M1, UE category M2, UE category NB1, UE category NB2 etc. In the following description, the terms “terminal node”, “terminal device”, “terminal”, “user equipment” and “UE” may be used interchangeably. As one example, a terminal node may represent a UE configured for communication in accordance with one or more communication standards promulgated by the 3rd Generation Partnership Project (3GPP), such as 5G standards, and/or the future standards. As used herein, a “user equipment” or “UE” may not necessarily have a “user” in the sense of a human user who owns and/or operates the relevant device. In some embodiments, a terminal node may be configured to transmit and/or receive information without direct human interaction. For instance, a terminal node may be designed to transmit information to a network node on a predetermined schedule, when triggered by an internal or external event, or in response to requests from the wireless communication network. Instead, a UE may represent a device that is intended for sale to, or operation by, a human user but that may not initially be associated with a specific human user.

As yet another example, in an Internet of Things (IoT) scenario, a terminal node may represent a machine or other device that performs monitoring and/or measurements, and transmits the results of such monitoring and/or measurements to another terminal node and/or network equipment. The terminal node may in this case be a machine-to-machine (M2M) device, which may in a 3GPP context be referred to as a machine-type communication (MTC) device. As one particular example, the terminal node may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal node may represent a vehicle or other equipment that is capable of monitoring and/or reporting on its operational status or other functions associated with its operation.

As used herein, a downlink transmission refers to a transmission from a network node to a terminal node, and an uplink transmission refers to a transmission in an opposite direction.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, NR NTN, IoT NTN, LTE NTN, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, SPDSCH, sPUCCH, sPUSCH, MPDCCH, NPDCCH, NPDSCH, E-PDCCH, PUSCH, PUCCH, NPUSCH etc.

The term time resource used herein may correspond to any type of physical resource or radio resource expressed in terms of length of time. Examples of time resources are: symbol, sub-slot, mini-slot, time slot, subframe, radio frame, TTI, interleaving time, frame, SFN cycle, hyper-SFN cycle, etc.

References in the specification to “one embodiment,” “an exemplary embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an exemplary embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

NR synchronization signal (SS) consists of primary SS (PSS) and secondary SS (SSS). NR physical broadcast channel (PBCH) carries the very basic system information. The combination of SS and PBCH is referred to as SSB in NR. Multiple SSBs are transmitted in a localized burst set. Within an SS burst set, multiple SSBs can be transmitted in different beams. The transmission of SSBs within a localized burst set is confined to a 5 ms window. The set of possible SSB time locations within an SS burst set depends on the numerology which in most cases is uniquely identified by the frequency band. The SSB periodicity can be configured from the value set {5, 10, 20, 40, 80, 160} ms (where the unit used in the configuration is subframe, which has a duration of 1 ms).

A UE does not need to perform measurements with the same periodicity as the SSB periodicity. Accordingly, the SSB measurement time configuration (SMTC) has been introduced for NR. The signaling of SMTC window informs the UE of the timing and periodicity of SSBs that the UE can use for measurements. The SMTC window periodicity can be configured from the value set {5, 10, 20, 40, 80, 160} ms, matching the possible SSB periodicities. The SMTC window duration can be configured from the value set {1, 2, 3, 4, 5} ms (where the unit used in the configuration is subframe, which has a duration of 1 ms).

The UE may use the same RF module for measurements of neighboring cells and data transmission in the serving cell. Measurement gaps allow the UE to suspend the data transmission in the serving cell and perform the measurements of neighboring cells. The measurement gap repetition periodicity can be configured from the value set {20, 40, 80, 160} ms, the gap length can be configured from the value set {1.5, 3, 3.5, 4, 5.5, 6, 10, 20} ms. Usually, the measurement gap length is configured to be larger than the SMTC window duration to allow for RF retuning time. Measurement gap time advance is also introduced to fine tune the relative position of the measurement gap with respect to the SMTC window. The measurement gap timing advance can be configured from the value set {0, 0.25, 0.5} ms.

The exemplary scenario comprises at least one UE which is operating in a first cell (cell1) served by a network node (NW1), and performing measurements on one or more serving cell(s) and one or more neighbor cells or neighbor frequencies, e.g. on serving carrier and/or one or more additional carriers configured for measurements. The UE may further be served by cell1. Any additional carrier may belong to the RAT of the serving carrier frequency. In this case if that carrier is non-serving carrier then it is called as inter-frequency carrier. The additional carrier may also belong to another RAT and in which case it is called as inter-RAT carrier. The term carrier may also interchangeably be called as carrier frequency, layer, frequency layer, carrier frequency layer etc. For consistency term carrier is used herein after.

The UE is configured to operate in low activity RRC state. Examples of low activity RRC states are RRC IDLE mode, RRC INACTIVE mode etc. In the low activity RRC state the UE may be configured with DRX cycle equal to or larger than certain DRX threshold (Hdrx). An example of Hdrx is 0.32 second. For example the UE may be configured with any of the following DRX cycles e.g. 320 ms, 640 ms, 1280 ms, 2560 ms etc. The UE may further be configured with an eDRX cycle (in addition to DRX cycle). In low activity RRC state the UE perform measurements on the serving cell (e.g. cell1) and may further perform measurements on one or more neighbor cells based on one or more rules for cell change (e.g. cell reselection). When only DRX is configured then the UE meets measurement requirements associated with that DRX. When eDRX is configured then the UE meets measurement requirements associated with that eDRX.

If the UE is configured with the parameter, T_{service}, to enable time-based measurements for cell reselection then the UE shall start to perform intra-frequency, inter-frequency or inter-RAT measurements before the T_{service}, regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ.

Regarding location-based reselection, If Srxlev≤SnonIntraSearchP or Squal≤SnonIntraSearchQ, or the distance between UE and serving cell reference location is larger than threshold configured, i.e. D_{distanceThresh}, the UE shall be able to evaluate whether a newly detectable intra-frequency cell meets the reselection criteria defined in 3GPP TS 38.304.

In practice, when T_{service} is configured and fulfilled (i.e. UE absolute time matches or exceeds T_{service}), it can indicate the serving cell's signal level/signal quality cannot meet requirement to maintain UE's connection to serving cell already or soon. But T_{service} may happen before or after expiring of 10 s for searches and measurements on new suitable cell. This may result in that 10 s is passed before the UE performs cell selection even after serving cell stops covering the current area.

The UE may regularly evaluate the distance (D_{UE_ref}) between the UE and the serving cell reference location (which is broadcasted) with the distance threshold (D_{distanceThresh}) (which is also broadcasted). Similarly in practice, even D_{distanceThresh} cannot explicitly and exactly indicate the time when serving cell stops covering the current area or signal level/signal quality when fulfilling D_{distanceThresh} e.g. when the magnitude of D_{UE_ref} becomes larger than D_{distanceThresh}. But the when the distance condition (D_{UE_ref}≥D_{distanceThresh}) then the UE should start measuring on target cell(s) immediately for enabling the UE to reselect to suitable cell. Also, the UE can determine the time instance when arriving at the position corresponding to the D_{distanceThresh}, based on available ephemeris data. It is therefore not always suitable or acceptable for the UE to wait 10s before the UE performs the cell selection.

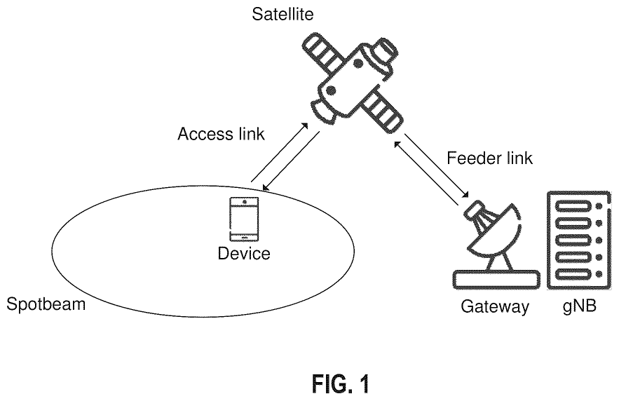

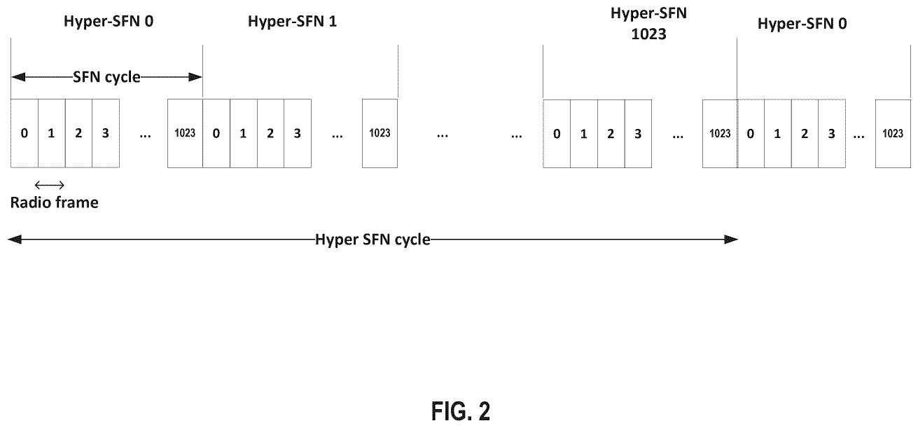

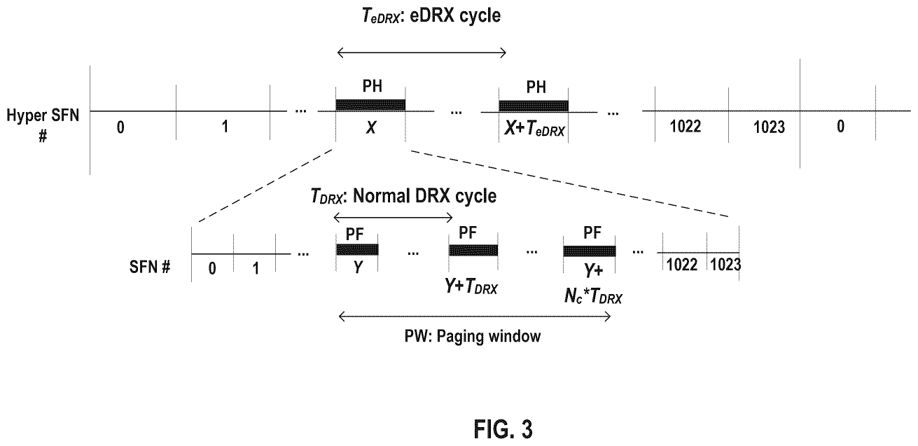

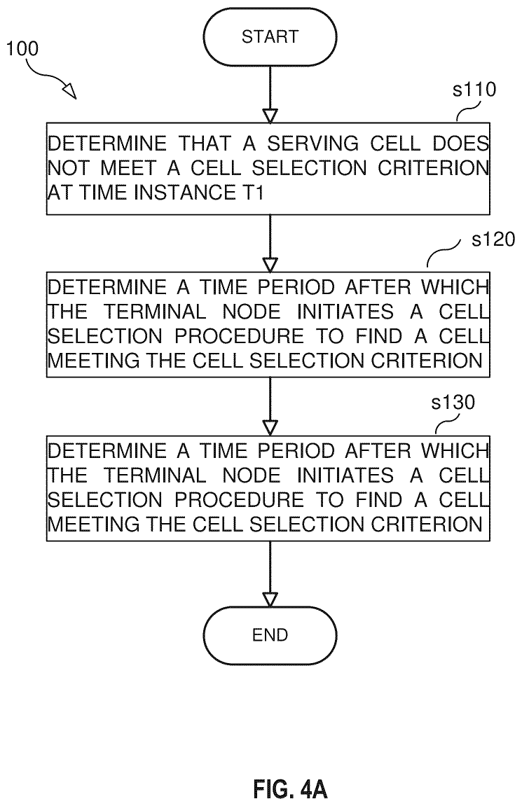

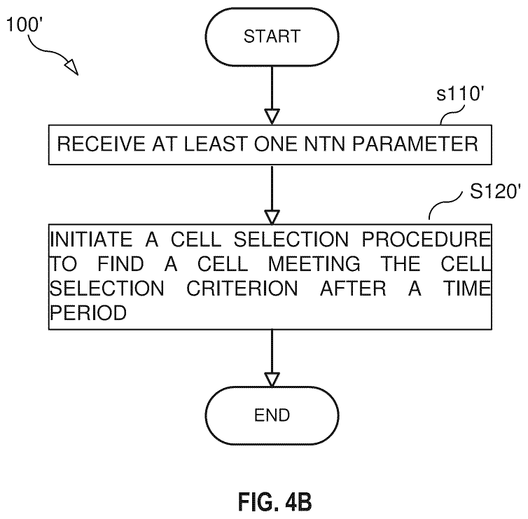

FIG. 4A is a flowchart illustrating a method 100 according to an exemplary embodiment of the present disclosure. The method 100 can be performed at a terminal node, e.g., a UE, and is to perform a cell selection procedure in a NTN system. The method 100 is applicable in a NTN network, as shown in FIG. 1.

At step s110, the terminal node determines whether a serving cell does not meet a cell selection criterion at time instance T1.

At step s120, in response to the determining in step s110 that the serving cell does not meet a cell selection criterion at time instance T1, the terminal node determines a time period after which the terminal node initiates a cell selection procedure to find a cell meeting the cell selection criterion. The determining of the time period is at least partially based on at least one obtained parameter and at least one NTN parameter defining a time and/or location relationship between the terminal node and the serving cell.

In an exemplary embodiment, the time period may start from the time instance T1.

In an exemplary embodiment, the obtained parameter may be pre-defined or received from a network node.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be the T_{service} mentioned above for example. The location parameter may be the D_{distanceThresh} mentioned above for example. Certainly, the NTN parameter may comprise any other parameter that defines the relation between the terminal node and the serving cell.

In an exemplary embodiment, the at least one obtained parameter comprises a time threshold, and the time period is the lower one of the time threshold and the service time parameter. In the embodiment, the terminal node performs searches and measurements for a suitable cell when it determines that the serving cell does not meet a cell selection criterion, and stops the searches and measurements when any one of the time threshold and the service time parameter arrives.

In an exemplary embodiment, the time period is equal to the obtained parameter, if the service time parameter is larger than the sum of T1 and the obtained parameter. In the embodiment, the service time parameter is beyond and far away from the time defined by the obtained parameter. The terminal node performs searches and measurements for a suitable cell when it determines that the serving cell does not meet a cell selection criterion, and stops the searches and measurements when the time defined by the obtained parameter arrives.

In an exemplary embodiment, the time period is equal to a magnitude of a difference between the service time parameter and T1, if the service time parameter is less than the sum of T1 and the obtained parameter. In the embodiment, the time defined by the obtained parameter may be beyond the service time parameter. The terminal node performs searches and measurements for a suitable cell when it determines that the serving cell does not meet a cell selection criterion, and stops the searches and measurements when the time defined by the service time parameter arrives.

In an exemplary embodiment, the at least one obtained parameter comprises a time threshold, and the time period is the lower one of the time threshold and a time instance T2 when a distance between the terminal node and the reference location of the service cell becomes equal to or larger than the distance threshold defined by the location parameter. In the embodiment, the terminal node performs searches and measurements for a suitable cell when it determines that the serving cell does not meet a cell selection criterion, and stops the searches and measurements when any one of the time threshold and the time instance T2 arrives.

In an exemplary embodiment, the time period is equal to the obtained parameter, if a time instance T2 is larger than or equal to the sum of T1 and the obtained parameter, where T2 is the time when a distance between the terminal node and the reference location of the service cell becomes equal to or larger than the distance threshold defined by the location parameter. In the embodiment, the time instance T2 is far away from the time defined by the obtained parameter. The terminal node performs searches and measurements for a suitable cell when it determines that the serving cell does not meet a cell selection criterion, and stops the searches and measurements when the time defined by the obtained parameter arrives.

In an exemplary embodiment, the time period is equal to a magnitude of a difference between a time instance T2 and T1, if T2 is less than the sum of T1 and the obtained parameter, where T2 is the time when a distance between the terminal node and the reference location of the service cell becomes equal to or larger than the distance threshold defined by the location parameter. In the embodiment, the time defined by the obtained parameter may be beyond the time instance T2. The terminal node performs searches and measurements for a suitable cell when it determines that the serving cell does not meet a cell selection criterion, and stops the searches and measurements when the time instance T2 arrives.

In an exemplary embodiment, the time threshold is a time length of 10 seconds. Certainly, any threshold may be defined or preconfigured or configured by the network node.

In an exemplary embodiment, the at least one obtained parameter comprises a time threshold, and the time period is zero if the service time parameter is lower than the time threshold. In the embodiment, if the time defined by the service time parameter arrives before the time threshold, the terminal node may be configured not to perform searches and measurements for a suitable cell, and rather initiates a cell selection procedure for a selected PLMN immediately after T1.

In an exemplary embodiment, the at least one obtained parameter comprises a time threshold, and the time period is zero if a time instance T2 is lower than the time threshold, where T2 is the time when a distance between the terminal node and the reference location of the service cell becomes equal to or larger than the distance threshold defined by the location parameter. In the embodiment, if the time instance T2 arrives before the time threshold, the terminal node may be configured not to perform searches and measurements for a suitable cell, and rather initiates a cell selection procedure for a selected PLMN immediately after T1.

In an exemplary embodiment, the terminal node may be further provided with a DRX cycle, and the time period is determined further based on a DRX cycle length.

In an exemplary embodiment, the terminal node may be further provided with an eDRX cycle, and the time period is determined further based on an eDRX cycle length.

In an exemplary embodiment, the time period is determined further based on a type of NTN node of the NTN system.

Examples of types of NTN nodes may comprise for example: (1) Geosynchronous Earth Orbit: Earth-centered orbit at approximately 35786 kilometers above Earth's surface and synchronized with Earth's rotation. A geostationary orbit is a non-inclined geosynchronous orbit, i.e. in the Earth's equator plane; (2) Low Earth Orbit: Orbit around the Earth with an altitude between 300 km, and 1500 km; and (3) Satellite: A space-borne vehicle embarking a bent pipe payload or a regenerative payload telecommunication transmitter, placed into Low-Earth Orbit (LEO), Medium-Earth Orbit (MEO), or Geostationary Earth Orbit (GEO).

In an exemplary embodiment, the method 100 may further comprise step s130 of initiating a cell selection procedure for a selected PLMN if no cell is found during the determined time period; or initiating a cell selection procedure for a selected PLMN immediately after T1 if the time period is determined to be zero.

In an exemplary embodiment, the terminal node operates in a low activity RRC state, for example RRC IDLE mode or RRC INACTIVITE mode.

In an exemplary embodiment, method 100 further comprises the UE receiving system information, and during the time period the UE searches for and measures one or more cells using the intra-frequency, inter-frequency, and inter-RAT information indicated in the system information.

In an exemplary embodiment, the one or more NTN parameters are pre-defined or

received from a network node.

In an exemplary embodiment, the one or more NTN parameters comprise: a service time parameter that indicates the time when the serving cell is going to stop serving an area it is currently covering, and/or a location parameter that indicates a distance threshold between the terminal node and a reference location of the serving cell.

In an exemplary embodiment, the one or more NTN parameters comprises a service time parameter, STP, that indicates the time when the serving cell is going to stop serving an area it is currently covering, the first obtained parameter comprises a time threshold, Thr, and the duration of the time period is the lower of Thr and (STP minus T1).

In an exemplary embodiment, the one or more NTN parameters comprises a service time parameter, STP, that indicates the time when the serving cell is going to stop serving an area it is currently covering, and, if the service time parameter is larger than T1, then the time period starts at T1 and has a duration of D, where D is the first obtained parameter.

In an exemplary embodiment, the one or more NTN parameters comprises a service time parameter, STP, that indicates the time when the serving cell is going to stop serving an area it is currently covering, and, if the service time parameter is less than or equal to T1, then then the time period starts at the service time parameter and has a duration of D, where D is the first obtained parameter.

In an exemplary embodiment, the one or more NTN parameters comprises a service time parameter, STP, that indicates the time when the serving cell is going to stop serving an area it is currently covering, the first obtained parameter comprises a time threshold, Thr, and the duration of the time period is zero if STP≤(T1+Thr).

In an exemplary embodiment, the time threshold is a time length of 10 seconds.

FIG. 4B is a flowchart illustrating a method 100′ according to another exemplary embodiment of the present disclosure. The method 100′ can be performed at a terminal node, e.g., a UE, and is to perform a cell selection procedure in a NTN system. The method 100′ is applicable in a NTN network, as shown in FIG. 1.

At step s110′, the terminal node receives at least one NTN parameter defining a time and/or location relationship between the terminal node and a serving cell.

At step s120′, in response to the receiving in step s110′, the terminal node initiates a cell selection procedure to find a cell meeting a cell selection criterion after a time period.

In an exemplary embodiment, the NTN parameter comprises at least one of a service time parameter that indicates the time when the serving cell is going to stop serving an area it is currently covering and a location parameter that indicates a distance threshold between the terminal node and a reference location of the serving cell.

In an exemplary embodiment, the time period starts from the time instance defined by the service time parameter.

In an exemplary embodiment, the time period starts from the time when a distance between the terminal node and the reference location of the service cell becomes equal to or larger than the distance threshold defined by the location parameter.

In an exemplary embodiment, the time period is a time of 10 seconds. In an example, the UE shall initiate cell selection procedures for the selected PLMN if the UE in RRC_IDLE has not found any new suitable cell based on searches and measurements using the intra-frequency, inter-frequency or inter-RAT information indicated in the system information within 10 seconds since the time the time when the serving cell is going to stop serving an area it is currently covering. In another example, the UE shall initiate cell selection procedures for the selected PLMN if the UE in RRC_IDLE has not found any new suitable cell based on searches and measurements using the intra-frequency, inter-frequency or inter-RAT information indicated in the system information within 10 seconds since the time when a distance between the terminal node and the reference location of the service cell becomes equal to or larger than the distance threshold defined by the location parameter.

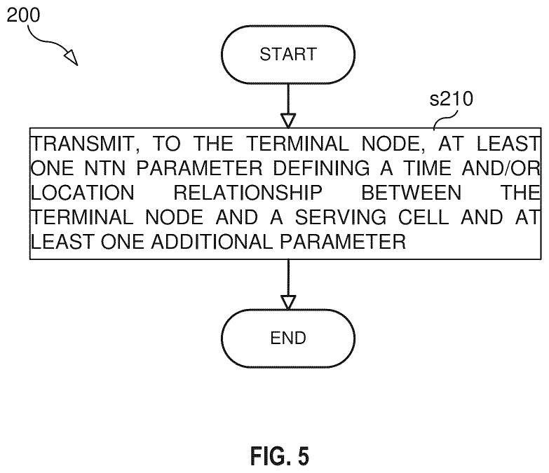

FIG. 5 is a flowchart illustrating a method 200 according to an exemplary embodiment of the present disclosure. The method 200 can be performed in a network node, e.g., a BS, and is to configure a terminal node in a NTN system. The method 200 is applicable in a NTN network, as shown in FIG. 1.

At step s210, the network node transmits, to the terminal node, at least one NTN parameter defining a time and/or location relationship between the terminal node and a serving cell and at least one additional parameter. The additional parameter and the NTN parameter will be used by the terminal node in determining a time period after which the terminal node initiates a cell selection procedure to find a cell meeting a cell selection criterion, after determining that the serving cell does not meet the cell selection criterion.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be T_{service} mentioned above for example. The location parameter may be D_{distanceThresh} mentioned above for example. Certainly, the NTN parameter may comprise any other parameter that defines the relation between the terminal node and the serving cell.

In an exemplary embodiment, the at least one additional parameter may comprise a time threshold after which the terminal node initiates the cell selection procedure. The terminal node may determine the time period by taking the time threshold and the time defined by the NTN parameter into account. For example, if the time defined by the NTN parameter is beyond the time threshold, the terminal node may stop the searches and measurements for a suitable cell when the time threshold arrives. As another example, if the time threshold is beyond the time defined by the NTN parameter, the terminal node may stop the searches and measurements for a suitable cell when the time defined by the NTN parameter.

In an exemplary embodiment, the at least one additional parameter may comprises a rule defining a way to consider a DRX cycle length or an eDRX cycle length in determining the time period. In the embodiment, the network node configures the terminal node with the rule to use the DRX cycle length or eDRX cycle length in determining the time period.

Some exemplary embodiments are described for assisting the skilled in the art to understanding the disclosure. It is sure that the disclosure is not limited to the embodiments, which are illustrated to convey the idea of the disclosure.

The embodiments described herein may also be implemented in any combination.

The following embodiment is related to a scenario where the UE performs serving cell measurements with T_{service} configured by the network node.

In the embodiment, the UE performs at least the following steps, i.e., step 1 and step 2.

### Step 1:

In this step, the UE performs serving cell measurements (e.g. SS-RSRP and SS-RSRQ measurements) to evaluate the serving cell selection criterion. If the UE has evaluated in Nₛₑᵣᵥ consecutive DRX cycles that the serving cell does not fulfill the cell selection criterion, then the UE performs searches and measurements. T_{fails} is the time instance at which or by which the UE has evaluated in Nₛₑᵣᵥ consecutive DRX cycles that the serving cell does not fulfill the cell selection criterion. T_{fails} is the time instance T1 described before in conjunction with FIGS. 4 and 5.

### Step 2:

In this step, the UE determines when to perform the cell selection procedure starting from Ts based on whether the UE is configured with T_{service} parameter associated with the serving cell as described in the following steps, where Ts is the time when the UE starts the cell selection procedures for the selected PLMN.

Step 2-1: If the UE is not configured with T_{service}, the UE performs one or more cell selection procedures for the selected PLMN if it has not found any new suitable cell within a time period ΔT=δt1, starting from time instance, T_{fails}, where: δt1=(Ts−T_{fails}).

In one example δt1=10 seconds. δt1 is a parameter predefined, or prefigured or configured by the network node. In the example, the UE is not configured with T_{service}, and it initiates cell selection procedures for the selected PLMN, if the UE in RRC_IDLE does not find any new suitable cell based on searches and measurements using the intra-frequency, inter-frequency and inter-RAT information indicated in the system information for 10 seconds.

Step 2-2: If the UE is configured with T_{service}, the UE performs one or more cell selection procedures for the selected PLMN if it has not found any new suitable cell within a time period, ΔT, starting from time instance, T_{fails}, where ΔT depends on the relation between T_{fails} and T_{service} as described below.

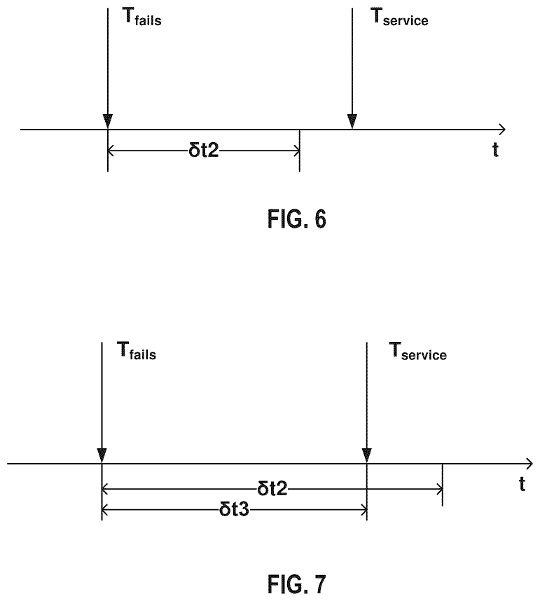

If (T_{fails}+δt2)≤T_{service}, as shown in FIG. 6, the UE performs Step 2-2-1.

Step 2-2-1: The UE performs one or more cell selection procedures for the selected PLMN if it has not found any new suitable cell within time period, ΔT=δt2, starting from time instance, T_{fails}. δt2 is a parameter predefined, or prefigured or configured by the network node.

FIG. 6 illustrates a timing relation between T_{fails} and T_{service} when they are far apart in time. T_{service} is far away from T_{fails} and beyond δt2. In the example, the UE initiates cell selection procedures for the selected PLMN, if the UE in RRC_IDLE does not find any new suitable cell based on searches and measurements using the intra-frequency, inter-frequency and inter-RAT information indicated in the system information for δt2.

In one example, δt2=δt1. For example, δt2=10 seconds. The UE performs one or more cell selection procedures for the selected PLMN if it has not found any new suitable cell within 10 seconds.

In another example, δt2=detection and measurement time on intra-frequency cells. The UE may try to find a suitable cell by performing intra-frequency measurements after time instance T_{fails}, and perform one or more cell selection procedures for the selected PLMN if it has not found any new suitable cell with the intra-frequency measurements.

In another example, δt2=K_{carrier}*detection and measurement time on inter-frequency cells. K_{carrier} is the number of NR inter-frequency carriers indicated by the serving cell. The UE may try to find a suitable cell by performing inter-frequency measurements after time instance T_{fails}, and perform one or more cell selection procedures for the selected PLMN if it has not found any new suitable cell with the inter-frequency measurements.

In another example, if (T_{fails}+δt2)≤T_{service}, the UE performs one or more cell selection procedures for the selected PLMN immediately at time instance T_{fails}. In the example, the time period is set to 0, and the UE is configured to perform one or more cell selection procedures for the selected PLMN immediately at the time instance T_{fails} when T_{service} is far away from T_{fails} and beyond δt2.

In another example, if (T_{fails}+δt2)≤T_{service}, the UE performs one or more cell selection procedures for the selected PLMN if it has not found any new suitable cell by the time instance T_{service}. In the example, the time period is set to a magnitude of a difference between T_{service} and T_{fails}.

If (T_{fails}+δt2)>T_{service}, as shown in FIG. 7, the UE performs Step 2-2-2:

Step 2-2-2: The UE performs one or more cell selection procedures for the selected PLMN if it has not found any new suitable cell within a time period, ΔT=δt3, starting from time instance, T_{fails}, where: δt3=(T_{service}−T_{fails}) where the UE starts the cell selection procedures for the selected PLMN at or after time instance T_{service}.

FIG. 7 illustrates a timing relation between T_{fails} and T_{service} when they are closer in time. T_{service} is within δt2 and close to T_{fails}. In the example, the time period may be set to a magnitude of a difference between T_{service} and T_{fails}, i.e., δt3.

In one example if δt2=0 then the UE starts the cell selection procedures for the selected PLMN immediately after determining that the UE does not meet the cell selection criterion for the serving cell, i.e., T_{fails}.

In another example, if (T_{fails}+δt2)>T_{service}, the UE performs one or more cell selection procedures for the selected PLMN immediately. In the example, δt2 is configured as a time threshold, and if T_{service} is lower than δt2, the UE is configured to perform one or more cell selection procedures for the selected PLMN immediately.

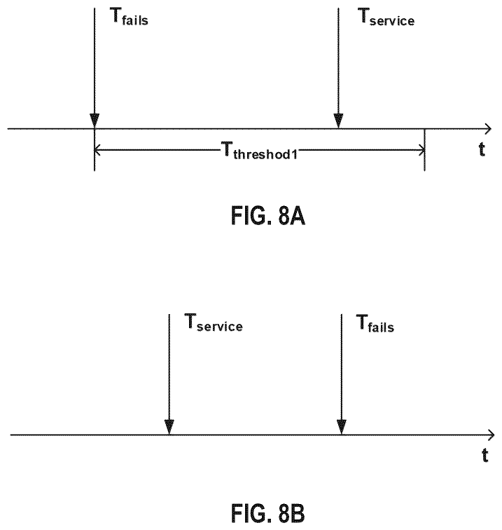

If (T_{service}−T_{fails})<T_{theshod1}, which is illustrated in FIG. 8A, then the UE performs Step 2-2-3:

Step 2-2-3: the UE performs one or more cell selection procedures for the selected PLMN immediately after T_{fails}. T_{theshod1} can be pre-defined or configured by the network node.

FIG. 8A illustrates a timing relation between T_{fails} and T_{service} when they are within a threshold T_{theshod1}. In the example, if T_{service} is lower than a time threshold, the UE is configured to perform one or more cell selection procedures for the selected PLMN immediately.

In one example, T_{theshod1}=5 s. T_{theshod1} also can be defined as a uniform fixed number suitable to all satellites or different fixed number for different satellite types/orbits, i.e., types of NTN node.

In another example, T_{theshod1}=K3*T_{DRX}. In another example, T_{theshod1}=K4*T_{eDRX}. The parameters K3 and K4 can be pre-defined or configured by the network node. In the example, the time threshold depends on the DRX cycle length or the eDRX cycle length.

### Step 2-3:

If T_{fails}>T_{service}, which is illustrated in FIG. 8B, the UE performs one or more cell selection procedures for the selected PLMN if it has not found any new suitable cell within a time period ΔT=δt4, starting from time instance, T_{service}. δt4 may be a parameter predefined, or prefigured or configured by the network node.

In the example, T_{service} arrives before T_{fails}.

FIG. 8B illustrates a timing relation between T_{fails} and T_{service} when T_{service} arrives before T_{fails}. In one example, δt4=δt2. In another example, δt4=δt1.

The following embodiment is related to a scenario where the UE performs serving cell measurements with D_{distanceThresh} and cell's reference location configured by the network node.

In the embodiment, the UE performs at least the following steps, i.e., step 1 and step 2.

### Step 1:

In this step, the UE performs serving cell measurements (e.g. SS-RSRP and SS-RSRQ measurements) to evaluate the serving cell selection criterion. If the UE has evaluated in Nₛₑᵣᵥ consecutive DRX cycles that the serving cell does not fulfill the cell selection criterion, the UE performs searches and measurements for a suitable cell. T_{fails} is the time instance at which or by which the UE has evaluated in Nₛₑᵣᵥ consecutive DRX cycles that the serving cell does not fulfill the cell selection criterion. T_{fails} is the time instance T1 described before in conjunction with FIGS. 4 and 5.

### Step 2:

In this step, the UE determines when to perform the cell selection procedure starting from Ts based on whether the UE is configured with the reference location associated with the serving cell as described in the following steps, where Ts is the time when the UE starts the cell selection procedures for the selected PLMN.

Step 2-1: If the UE is not configured with D_{distanceThresh} and the reference location of the serving cell, then the UE performs one or more cell selection procedures for the selected PLMN if it has not found any new suitable cell within a time period ΔT=δt1, starting from time instance, T_{fails}, where: δt1=(Ts−T_{fails}).

In one example δt1=10 seconds. δt1 is a parameter predefined, or prefigured or configured by the network node. In the example, the UE is not configured with D_{distanceThresh} and the reference location of the serving cell, and it initiates cell selection procedures for the selected PLMN, if the UE in RRC_IDLE does not find any new suitable cell based on searches and measurements using the intra-frequency, inter-frequency and inter-RAT information indicated in the system information for 10 seconds.

Step 2-2: If the UE is configured with the reference location of the serving cell, the UE performs one or more cell selection procedures for the selected PLMN if it has not found any new suitable cell within a time period, ΔT, starting from time instance, T_{fails}, where ΔT depends on the magnitude of the distance (ΔD) between the UE's location and the reference location of the serving cell as described below.

If ΔD<H1 then the UE performs Step 2-2-1.

Step 2-2-1: The UE performs one or more cell selection procedures for the selected PLMN if it has not found any new suitable cell within time period, ΔT=δt2, starting from time instance, T_{fails}. δt2 and H1 each are parameters predefined, or prefigured or configured by the network node. In the example, UE is close to the reference location of the serving cell, i.e., the distance therebetween is lower than a threshold, H1, and the UE initiates cell selection procedures for the selected PLMN, if the UE in RRC_IDLE does not find any new suitable cell based on searches and measurements using the intra-frequency, inter-frequency and inter-RAT information indicated in the system information for δt2.

If ΔD>threshold (H1) then the UE performs Step 2-2-2:

Step 2-2-2: The UE performs one or more cell selection procedures for the selected PLMN if it has not found any new suitable cell within time period within time period, ΔT=δt4, starting from time instance, T_{fails}, where: δt4=(T_{D_ref}−T_{fails}) where T_{D_ref} is the time when ΔD becomes equal to or larger than a threshold (H2). In the example, the UE is not close to the reference location of the serving cell (i.e., ΔD is larger than H1), and moving away from the reference location of the serving cell. The UE starts the cell selection procedures for the selected PLMN at or after it is away from the reference location of the serving cell by a threshold (H2), i.e., at a time instance T_{D_ref}.

In one example, H2>H1. In another example, H2=H1. In the latter case in one example, δt4=0. I.e. UE immediately starts the cell selection procedures after T_{fails}. H1 and H2 may be defined directly or function of D_{distanceThresh}, and may be predefined or configured by the network node.

In one example H1=D_{distanceThresh}+D_{margin}, D_{margin} can be equal to 0 m or 50 m for example.

In another example, if (T_{fails}+δt2)≤T_{D_ref}, the UE performs one or more cell selection procedures for the selected PLMN immediately. In the example, if the UE is close to the reference location of the serving cell, and will move away from the reference location of the serving cell by a threshold (H2) after a long time, the UE is configured to perform one or more cell selection procedures for the selected PLMN immediately.

In another example, if (T_{fails}+δt2)≤T_{D_ref}, the UE performs one or more cell selection procedures for the selected PLMN at or after T_{D_ref}. In the example, if the UE is close to the reference location of the serving cell, and will move away from the reference location of the serving cell by a threshold (H2) after a long time, the UE is configured to perform one or more cell selection procedures for the selected PLMN if it has not found any new suitable cell within T_{D_ref}.

If (T_{fails}+T_{theshod1})>T_{D_ref}, then the UE performs Step 2-2-3:

Step 2-2-3: The UE shall perform one or more cell selection procedures for the selected PLMN immediately. In the example, the UE will move away from the reference location of the serving cell by a threshold (H2) within a short time (T_{theshod1}>T_{D_ref}−T_{fails}), and it is configured to perform one or more cell selection procedures for the selected PLMN immediately.

In another example, if (T_{fails}+T_{theshod1})>T_{D_ref}, then the UE performs one or more cell selection procedures for the selected PLMN if it has not found any new suitable cell within time period, ΔT=δt1, starting from time instance, T_{D_ref}.

In one example, T_{theshod1}=5 s. T_{theshod1} also can be defined as a uniform fixed number suitable to all satellites or different fixed number for different satellite types/orbits, i.e., types of NTN node.

In another example, T_{theshod1}=K3*T_{DRX}. In another example, T_{theshod1}=K4*T_{eDRX}. The parameters K3 and K4 can be pre-defined or configured by the network node. In the example, the time threshold depends on the DRX cycle length or the eDRX cycle length.

In another example T_{theshod1}=0, i.e. T_{fails}>T_{D_ref}. In the example, T_{D_ref} arrives before T_{fails}. The UE performs one or more cell selection procedures for the selected PLMN if it has not found any new suitable cell within a time period ΔT=δt4, starting from time instance, T_{D_ref}. δt4 may be a parameter predefined, or prefigured or configured by the network node.

The following embodiment is related to a scenario where the UE performs serving cell measurements in a normal DRX cycle.

The embodiments described herein may also be implemented in any combination.

In the embodiment, the UE performs at least the following steps, i.e., step 1 and step 2.

### Step 1:

In this step, the UE performs normal serving cell measurements based on SS-RSRP and SS-RSRQ measurements. If the UE has evaluated in Nₛₑᵣᵥ consecutive DRX cycles that the serving cell does not fulfill the cell selection criterion, UE performs searches and measurements.

### Step 2:

UE performs one or more cell selection procedures for the selected PLMN if it has not found any new suitable cell within time period, ΔT, starting from T_{fails}. T_{fails} is the same as defined in the other embodiments. That is, T_{fails} is the time instance T1 described before in conjunction with FIGS. 4A and 5.

Before performing the one or more cell selection procedures, the UE may further determine the time period, ΔT, based on a rule, which may be pre-defined or configured by a network node or autonomously determined by the UE.

Any of the parameters, δt1 and δt2, described in previous embodiments may correspond to ΔT described here with examples.

The time period, ΔT is expressed by a general function as follows: ΔT=f1(β, K, T_{DRX}).

Examples of functions are maximum, average, sum, product, minimum, ceil, floor, etc, and any combinations of such functions.

In one example assume β=10 seconds and K=M1*N1*K1, ΔT can be expressed by the following function: ΔT=max (10 s, M1*N1*P1*K1*T_{DRX})
where, as examples:
M1=2 if SMTC periodicity (TSMTC)>20 ms and DRX cycle length (T_{DRX})≤0.64 second, otherwise M1=1;
N1=1 for FR1 serving cell. In FR2, in one example, N1=8 for T_{DRX}=0.32 s, 5 for T_{DRX}=0.64 s, 4 for T_{DRX}=1.28 s and 3 for T_{DRX}=2.56 s. In FR2, in another example, N1=8;
P1 is scaling factor which differentiates with N1 for Rx beam in FR2, also it may depend on the type of satellite serving or operating the cell on which the UE performs the measurements. Examples of type of satellites are LEO, MEO, GEO etc. Satellites may be time critical (e.g. LEO or MEO whose coverage wrt the UE location changes over time) or time non-critical (e.g. GEO whose coverage wrt the UE location does not change over time or changes insignificantly over time). Examples of N1 comprise: P1=1 for cells served by time critical satellites configured to UE or to be detected by the UE e.g. LEO satellites or hybrid of LEO satellites and GEO satellites; P1=2 or 4 for cells served by time non-critical satellites configured to UE or to be detected by the UE, e.g. GEO satellites; P1=1 or 2 when some cells are served by time critical satellites and some cells are served by non-time critical satellites; and
K1=6 for T_{DRX}=0.32, 0.64 s and 3 for T_{DRX}=1.28, 2.56 s.

In another example, ΔT=max (10 s, (M1*N1*K2*T_{DRX}+J2*T_{DRX})), where, as examples: M1=2 if SMTC periodicity (TSMTC)>20 ms and T_{DRX}≤0.64 second, otherwise M1=1; N1=1 for cell served by LEO satellite, N=2 or 4 for cells served by GEO satellites; K1=4 for T_{DRX}=0.32, 0.64 s and 2 for T_{DRX}=1.28, 2.56 s; J2=2.

In another example, K=N1*K1, ΔT can be expressed by the following function: ΔT=max(β, N1*K1*T_{DRX}).

Examples of β are 10 s, 40 s etc. Values of N1 and K1 in the above expression can be the same as in previous examples.

In another example K=N1, ΔT can be expressed by the following function: ΔT=max (β, N1*T_{DRX})

Examples of β are 10 s, 40 s etc. In the above expression, the values of N1 when cells are served by LEO or GEO satellites, may differ and can be the same as in previous examples.

The following embodiment is related to a scenario where the UE performs serving cell measurements in an eDRX cycle.

The embodiments described herein may also be implemented in any combination.

In the embodiment, the UE performs at least the following steps, i.e., step 1 and step 2.

### Step 1:

In this step, the UE performs normal serving cell measurements based on SS-RSRP and SS-RSRQ measurements. If the UE has evaluated in Nₛₑᵣᵥ consecutive DRX cycles that the serving cell does not fulfill the cell selection criterion, UE performs searches and measurements.

### Step 2:

UE performs one or more cell selection procedures for the selected PLMN if it has not found any new suitable cell within time period, ΔT, starting from T_{fails}. T_{fails} is the same as defined in the other embodiments. That is, T_{fails} is the time instance T1 described before in conjunction with FIGS. 4A and 5.

Before performing the one or more cell selection procedures the UE may further determine the time period, ΔT, based on a rule, which may be pre-defined or configured by a network node or autonomously determined by the UE.

Any of the parameters, δt1 and δt2, described in previous embodiments may correspond to ΔT described here with examples.

The time period, ΔT, is expressed by a general function as follows: ΔT=f2 (u, G, T_{eDRX}).

Examples of functions are maximum, average, sum, product, minimum, ceil, floor, etc, and any combinations of such functions.

If the UE is configured with T_{eDRX} (eDRX cycle length) smaller or equal to 10.24 s, there may be the following examples.

In one example, assume μ=10 s and G=P3*K3, ΔT can be expressed as follows:

ΔT=max(10 s, P3*K3*T_{eDRX}), where, as examples: (1) K3=4 and (2) P3 is scaling factor which differentiates with N1 for Rx beam in FR2, also may depend on the type of satellite serving or operating the cell on which the UE performs the measurements. Examples of type of satellites are LEO, MEO, GEO etc. Satellites may be time critical (e.g. LEO or MEO whose coverage wrt the UE location changes over time) or time non-critical (e.g. GEO whose coverage wrt the UE location does not change over time or changes insignificantly over time). Examples of N3 are: (1) P3=1 for cells served by time critical satellites configured to UE or to be detected by the UE e.g. LEO satellites or hybrid of LEO satellites and GEO satellites; (2) P3=2 or 4 for cells served by time non-critical satellites configured to UE or to be detected by the UE, e.g. GEO satellites; and (3) P3=1 or 2 when some cells are served by time critical satellites and some cells are served by non-time critical satellites.

In another example G=P3, then ΔT can be expressed as follows: ΔT=max (μ, P3*T_{eDRX}), where examples of μ are 10 s, 40 s etc. and P3 may depend on the type of satellite serving or operating the cell on which the UE performs the measurements. Examples of N3 are the same as in the above examples.

In another example, ΔT=max (10 s, P4*K3*T_{eDRX}+J3*T_{eDRX}), where J3=2 and P3 may depend on the type of satellite serving or operating the cell on which the UE performs the measurements. Examples of N3 are the same as in the above examples.

If the UE is configured with T_{eDRX} (eDRX cycle length) larger than 10.24 s, there may be the following examples.

In one example, ΔT=max (10 s, L3*T_{eDRX}), where L3=1.

In another example, ΔT=max (10 s, L3*T_{eDRX}), where

$$L 3 = ⌈ \frac{N 1 * 2}{PTW / DRX} ⌉ .$$

Some of the afore-mentioned embodiments are further described below with specific examples.

In one exemplary embodiment, if the UE has evaluated according to Table 2 below in Nₛₑᵣᵥ consecutive DRX cycles that the serving cell does not fulfil the cell selection criterion S, the UE shall initiate the measurements of all neighbour cells indicated by the serving cell, regardless of the measurement rules currently limiting UE measurement activities. In this exemplary scenario the UE performs the following procedure:

(1) If the UE is not configured with the parameters, ‘t-Service’ or ‘distanceThresh’, in the serving cell and if the UE in low activity RRC state (e.g. RRC_IDLE, RRC_INACTIVE etc) has not found any new suitable cell based on searches and measurements using the intra-frequency, inter-frequency and inter-RAT information indicated in the system information for Y1 seconds (e.g. 10 s), then the UE shall initiate cell selection procedures for the selected PLMN.

(2) If the UE is configured with ‘t-Service’ in the serving cell, the UE shall initiate cell selection procedures for the selected PLMN when any of the following conditions is fulfilled: (A) if the UE in low activity RRC state (e.g. RRC_IDLE, RRC_INACTIVE etc) has not found any new suitable cell based on searches and measurements using the intra-frequency, inter-frequency and inter-RAT information indicated in the system information within Y1 seconds (e.g. 10 s) since the time instance T1 provided that ‘t-Service’>(T1+Y1) seconds, or (B) if the UE in low activity RRC state (e.g. RRC_IDLE, RRC_INACTIVE etc) has not found any new suitable cell based on searches and measurements using the intra-frequency, inter-frequency and inter-RAT information indicated in the system information until the time instance ‘t-Service’ provided that ‘t-Service’≤(T1+Y1) seconds, where T1 is the time instance in seconds when the UE has determined that the serving cell does not fulfil the cell selection criterion S.

(3) If the UE is configured with ‘t-Service’ in the serving cell then the UE shall initiate cell selection procedures for the selected PLMN when any of the following conditions is fulfilled: (A) If the UE in RRC_IDLE has not found any new suitable cell based on searches and measurements using the intra-frequency, inter-frequency and inter-RAT information indicated in the system information within Y1 second (e.g., 10 s) since time instance T1 provided that ‘t-Service’>T1; or (B) If the UE in RRC_IDLE has not found any new suitable cell based on searches and measurements using the intra-frequency, inter-frequency and inter-RAT information indicated in the system information within Y1 second (e.g., 10 s) since the time instance ‘t-Service’, where T1 is the time instance in seconds when the UE has determined that the serving cell does not fulfil the cell selection criterion S.

(4) If the UE is configured with ‘distanceThresh’ in the serving cell then the UE shall initiate cell selection procedures for the selected PLMN when any of the following conditions is fulfilled: (A) If the UE in low activity RRC state (e.g. RRC_IDLE, RRC_INACTIVE etc) has not found any new suitable cell based on searches and measurements using the intra-frequency, inter-frequency and inter-RAT information indicated in the system information within Y1 seconds (e.g. 10 s) since T1 provided that T2>(T1+Y1) seconds, or (B) If the UE in low activity RRC state (e.g. RRC_IDLE, RRC_INACTIVE etc) has not found any new suitable cell based on searches and measurements using the intra-frequency, inter-frequency and inter-RAT information indicated in the system information until the time instance T2 provided that T2≤(T1+Y1) seconds, where T2 is the time instance in seconds when the magnitude of the distance between the UE location and the serving cell's reference location becomes equal to or larger than distanceThresh.

(5) If the UE is configured with ‘distanceThresh’ in the serving cell then the UE shall initiate cell selection procedures for the selected PLMN when any of the following conditions is fulfilled: (A) If the UE in RRC_IDLE has not found any new suitable cell based on searches and measurements using the intra-frequency, inter-frequency and inter-RAT information indicated in the system information within Y1 second (e.g., 10 s) since time instance T1 provided that T2>T1; or (B) If the UE in RRC_IDLE has not found any new suitable cell based on searches and measurements using the intra-frequency, inter-frequency and inter-RAT information indicated in the system information within Y1 seconds (e.g., 10 s) since T2, where T2 is the time instance in seconds when the magnitude of the distance between the UE location and the serving cell's reference location becomes equal to or larger than distanceThresh.

TABLE 2
Nₛₑᵣᵥ

| | Nₛₑᵣᵥ |
|---|---|
| DRX cycle | [number of |
| length [s] | DRX cycles] |
| 0.32 | M1*4 |
| 0.64 | M1*4 |
| 1.28 | 2 |
| 2.56 | 2 |

Note 1:
The UE is not required to meet the requirements for 2.56 s DRX cycle length for earth-moving LEO deployment.
Note 2:
M1 = 2 if SMTC periodicity (TSMTC) > 20 ms and DRX cycle ≤ 0.64 second. Otherwise M1 = 1.

The above embodiments are illustrated as examples only. The present disclosure is not limited thereto.

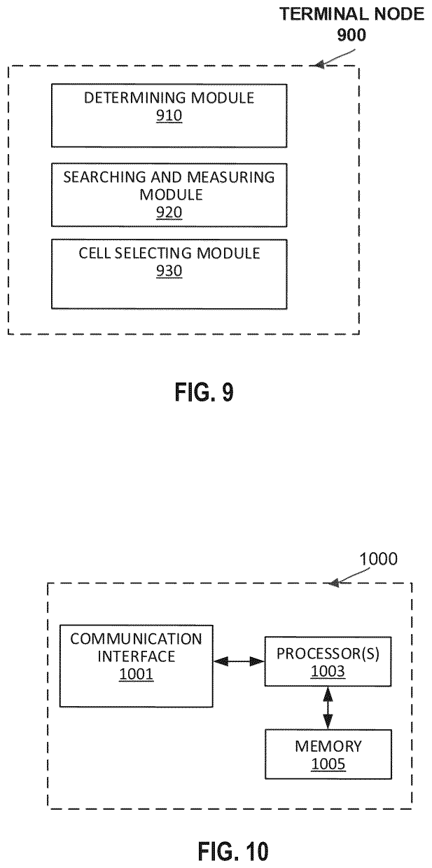

Correspondingly to the method 100 as described above, a terminal node is provided. FIG. 9 is a block diagram of a terminal node 900 according to an exemplary embodiment of the present disclosure.

As shown in FIG. 9, the terminal node 900 includes a determining module 910 configured to determine that a serving cell does not meet a cell selection criterion at time instance T1, and in response to the determining, determine a time period after which the terminal node initiates a cell selection procedure to find a cell meeting the cell selection criterion. The determining module 910 is configured to determine a time period after which the terminal node initiates a cell selection procedure to find a cell meeting the cell selection criterion, at least partially based on at least one obtained parameter and at least one NTN parameter defining a time and/or location relationship between the terminal node and the serving cell.

The terminal node 900 may further include a searching and measuring module 920 configured to perform searches and measurements within the time period determined by the determining module 910, and a cell selecting module 930 configured to perform a cell selection procedure to find a cell meeting the cell selection criterion.

The determining module 910, the searching and measuring module 920, and the cell selecting module 930 of the terminal node 900 may be configured to perform the actions discussed with FIGS. 4A and 4B to implement the function of the terminal node. It will be understood by the skilled in the art, common components in the terminal node 900 are omitted in FIG. 9 for not obscuring the idea of the present disclosure. Also, some modules may be distributed in more modules or integrated into fewer modules.

The modules 910-930 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4A and FIG. 4B.

In an exemplary embodiment, the time period may start from the time instance T1.

In an exemplary embodiment, the obtained parameter may be pre-defined or received from a network node.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be the T_{service} mentioned above for example. The location parameter may be the D_{distanceThresh} mentioned above for example. Certainly, the NTN parameter may comprise any other parameter that defines the relation between the terminal node and the serving cell.

In an exemplary embodiment, the at least one obtained parameter comprises a time threshold, and the time period is the lower one of the time threshold and the service time parameter. In the embodiment, the searching and measuring module 920 of the terminal node 900 performs searches and measurements for a suitable cell when the determining module 910 determines that the serving cell does not meet a cell selection criterion, and stops the searches and measurements when any one of the time threshold and the service time parameter arrives.

In an exemplary embodiment, the time period is equal to the obtained parameter, if the service time parameter is larger than the sum of T1 and the obtained parameter. In the embodiment, the service time parameter is beyond and far away from the time defined by the obtained parameter. The searching and measuring module 920 of the terminal node 900 performs searches and measurements for a suitable cell when the determining module 910 determines that the serving cell does not meet a cell selection criterion, and stops the searches and measurements when the time defined by the obtained parameter arrives.

In an exemplary embodiment, the time period is equal to a magnitude of a difference between the service time parameter and T1, if the service time parameter is less than the sum of T1 and the obtained parameter. In the embodiment, the time defined by the obtained parameter may be beyond the service time parameter. The searching and measuring module 920 of the terminal node 900 performs searches and measurements for a suitable cell when the determining module 910 determines that the serving cell does not meet a cell selection criterion, and stops the searches and measurements when the time defined by the service time parameter arrives.

In an exemplary embodiment, the at least one obtained parameter comprises a time threshold, and the time period is the lower one of the time threshold and a time instance T2 when a distance between the terminal node and the reference location of the service cell becomes equal to or larger than the distance threshold defined by the location parameter. In the embodiment, the searching and measuring module 920 of the terminal node 900 performs searches and measurements for a suitable cell when the determining module 910 determines that the serving cell does not meet a cell selection criterion, and stops the searches and measurements when any one of the time threshold and the time instance T2 arrives.

In an exemplary embodiment, the time period is equal to the obtained parameter, if a time instance T2 is larger than or equal to the sum of T1 and the obtained parameter, where T2 is the time when a distance between the terminal node and the reference location of the service cell becomes equal to or larger than the distance threshold defined by the location parameter. In the embodiment, the time instance T2 is far away from the time defined by the obtained parameter. The searching and measuring module 920 of the terminal node 900 performs searches and measurements for a suitable cell when the determining module 910 determines that the serving cell does not meet a cell selection criterion, and stops the searches and measurements when the time defined by the obtained parameter arrives.

In an exemplary embodiment, the time period is equal to a magnitude of a difference between a time instance T2 and T1, if T2 is less than the sum of T1 and the obtained parameter, where T2 is the time when a distance between the terminal node and the reference location of the service cell becomes equal to or larger than the distance threshold defined by the location parameter. In the embodiment, the time defined by the obtained parameter may be beyond the time instance T2. The searching and measuring module 920 of the terminal node 900 performs searches and measurements for a suitable cell when the determining module 910 determines that the serving cell does not meet a cell selection criterion, and stops the searches and measurements when the time instance T2 arrives.

In an exemplary embodiment, the time threshold is a time length of 10 seconds. Certainly, any threshold may be defined or preconfigured or configured by the network node.

In an exemplary embodiment, the at least one obtained parameter comprises a time threshold, and the time period is zero if the service time parameter is lower than the time threshold. In the embodiment, if the time defined by the service time parameter arrives before the time threshold, the searching and measuring module 920 of the terminal node 900 may be configured not to perform searches and measurements for a suitable cell, and rather the cell selecting module 930 initiates a cell selection procedure for a selected PLMN immediately after T1.

In an exemplary embodiment, the at least one obtained parameter comprises a time threshold, and the time period is zero if a time instance T2 is lower than the time threshold, where T2 is the time when a distance between the terminal node and the reference location of the service cell becomes equal to or larger than the distance threshold defined by the location parameter. In the embodiment, if the time instance T2 arrives before the time threshold, the searching and measuring module 920 of the terminal node 900 may be configured not to perform searches and measurements for a suitable cell, and rather the cell selecting module 930 initiates a cell selection procedure for a selected PLMN immediately after T1.

In an exemplary embodiment, the terminal node 900 may be further provided with a DRX cycle, and the time period is determined further based on a DRX cycle length.

In an exemplary embodiment, the terminal node 900 may be further provided with an eDRx cycle, and the time period is determined further based on an eDRX cycle length.

In an exemplary embodiment, the time period is determined further based on a type of NTN node of the NTN system.

In an exemplary embodiment, the cell selecting module 930 may initiate a cell selection procedure for a selected PLMN if no cell is found by the searching and measuring module 920 during the determined time period; or initiate a cell selection procedure for a selected PLMN immediately after T1 if the time period is determined to be zero.

In an exemplary embodiment, the terminal node 900 operates in a low activity RRC state, for example RRC IDLE mode or RRC INACTIVITE mode.

In an exemplary embodiment of the present disclosure, the cell selecting module 930 of the terminal node 900 may be configured to, in response to the terminal node 900 receiving at least one NTN parameter defining a time and/or location relationship between the terminal node and a serving cell, initiate a cell selection procedure to find a cell meeting the cell selection criterion after a time period.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be the T_{service} mentioned above for example. The location parameter may be the D_{distanceThresh} mentioned above for example. Certainly, the NTN parameter may comprise any other parameter that defines the relation between the terminal node and the serving cell.

In an exemplary embodiment, the time period starts from the time instance defined by the service time parameter.

In an exemplary embodiment, the time period starts from the time when a distance between the terminal node and the reference location of the service cell becomes equal to or larger than the distance threshold defined by the location parameter.

In an exemplary embodiment, the time period is a time of 10 seconds.

FIG. 10 is a block diagram of a terminal node 1000 according to another embodiment of the present disclosure. The terminal node 1000 in FIG. 10 may perform the method 100 for performing a cell selection procedure described previously with reference to FIG. 4A and FIG. 4B. Accordingly, some detailed description on the terminal node 1000 may refer to the corresponding description of the method 100 for performing a cell selection procedure as previously discussed.

As shown in FIG. 10, the terminal node 1000 may include at least one controller or processor 1003 including e.g., any suitable Central Processing Unit, CPU, microcontroller, Digital Signal Processor, DSP, etc., capable of executing computer program instructions. The computer program instructions may be stored in a memory 1005. The memory 1005 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary terminal node 1000 further comprises a communication interface 1001 arranged for communication.

The instructions, when loaded from the memory 1005 and executed by the at least one processor 1003, may cause the terminal node 1000 to perform the method 100 for performing a cell selection procedure as previously discussed.

In particular, in an exemplary embodiment of the present disclosure, the instructions, when loaded from the memory 1005 and executed by the at least one processor 1003, may cause the terminal node 1000 to, in response to determining that a serving cell does not meet a cell selection criterion at time instance T1, determine a time period after which the terminal node initiates a cell selection procedure to find a cell meeting the cell selection criterion. The determining of the time period is at least partially based on at least one obtained parameter and at least one NTN parameter defining a time and/or location relationship between the terminal node and the serving cell.

In an exemplary embodiment, the time period may start from the time instance T1.

In an exemplary embodiment, the obtained parameter may be pre-defined or received from a network node.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be the T_{service} mentioned above for example. The location parameter may be the D_{distanceThresh} mentioned above for example. Certainly, the NTN parameter may comprise any other parameter that defines the relation between the terminal node and the serving cell.

In an exemplary embodiment, the at least one obtained parameter comprises a time threshold, and the time period is the lower one of the time threshold and the service time parameter. In the embodiment, the instructions, when loaded from the memory 1005 and executed by the at least one processor 1003, may cause the terminal node 1000 to perform searches and measurements for a suitable cell when it determines that the serving cell does not meet a cell selection criterion, and stop the searches and measurements when any one of the time threshold and the service time parameter arrives.

In an exemplary embodiment, the time period is equal to the obtained parameter, if the service time parameter is larger than the sum of T1 and the obtained parameter. In the embodiment, the service time parameter is beyond and far away from the time defined by the obtained parameter. The instructions, when loaded from the memory 1005 and executed by the at least one processor 1003, may cause the terminal node 1000 to perform searches and measurements for a suitable cell when it determines that the serving cell does not meet a cell selection criterion, and stop the searches and measurements when the time defined by the obtained parameter arrives.

In an exemplary embodiment, the time period is equal to a magnitude of a difference between the service time parameter and T1, if the service time parameter is less than the sum of T1 and the obtained parameter. In the embodiment, the time defined by the obtained parameter may be beyond the service time parameter. The instructions, when loaded from the memory 1005 and executed by the at least one processor 1003, may cause the terminal node 1000 to perform searches and measurements for a suitable cell when it determines that the serving cell does not meet a cell selection criterion, and stops the searches and measurements when the time defined by the service time parameter arrives.

In an exemplary embodiment, the at least one obtained parameter comprises a time threshold, and the time period is the lower one of the time threshold and a time instance T2 when a distance between the terminal node and the reference location of the service cell becomes equal to or larger than the distance threshold defined by the location parameter. In the embodiment, the instructions, when loaded from the memory 1005 and executed by the at least one processor 1003, may cause the terminal node 1000 to perform searches and measurements for a suitable cell when it determines that the serving cell does not meet a cell selection criterion, and stop the searches and measurements when any one of the time threshold and the time instance T2 arrives.

In an exemplary embodiment, the time period is equal to the obtained parameter, if a time instance T2 is larger than or equal to the sum of T1 and the obtained parameter, where T2 is the time when a distance between the terminal node and the reference location of the service cell becomes equal to or larger than the distance threshold defined by the location parameter. In the embodiment, the time instance T2 is far away from the time defined by the obtained parameter. The instructions, when loaded from the memory 1005 and executed by the at least one processor 1003, may cause the terminal node 1000 to perform searches and measurements for a suitable cell when it determines that the serving cell does not meet a cell selection criterion, and stop the searches and measurements when the time defined by the obtained parameter arrives.

In an exemplary embodiment, the time period is equal to a magnitude of a difference between a time instance T2 and T1, if T2 is less than the sum of T1 and the obtained parameter, where T2 is the time when a distance between the terminal node and the reference location of the service cell becomes equal to or larger than the distance threshold defined by the location parameter. In the embodiment, the time defined by the obtained parameter may be beyond the time instance T2. The instructions, when loaded from the memory 1005 and executed by the at least one processor 1003, may cause the terminal node 1000 to perform searches and measurements for a suitable cell when it determines that the serving cell does not meet a cell selection criterion, and stop the searches and measurements when the time instance T2 arrives.

In an exemplary embodiment, the time threshold is a time length of 10 seconds. Certainly, any threshold may be defined or preconfigured or configured by the network node.

In an exemplary embodiment, the at least one obtained parameter comprises a time threshold, and the time period is zero if the service time parameter is lower than the time threshold. In the embodiment, the time defined by the service time parameter arrives before the time threshold, and the instructions, when loaded from the memory 1005 and executed by the at least one processor 1003, may cause the terminal node 1000 to initiate a cell selection procedure for a selected PLMN immediately after T1.

In an exemplary embodiment, the at least one obtained parameter comprises a time threshold, and the time period is zero if a time instance T2 is lower than the time threshold, where T2 is the time when a distance between the terminal node and the reference location of the service cell becomes equal to or larger than the distance threshold defined by the location parameter. In the embodiment, the time instance T2 arrives before the time threshold, and the instructions, when loaded from the memory 1005 and executed by the at least one processor 1003, may cause the terminal node 1000 to initiate a cell selection procedure for a selected PLMN immediately after T1.

In an exemplary embodiment, the terminal node 1000 may be further provided with a DRX cycle, and the time period is determined further based on a DRX cycle length.

In an exemplary embodiment, the terminal node 1000 may be further provided with an eDRx cycle, and the time period is determined further based on an eDRX cycle length.

In an exemplary embodiment, the time period is determined further based on a type of NTN node of the NTN system.

In an exemplary embodiment, the instructions, when loaded from the memory 1005 and executed by the at least one processor 1003, may cause the terminal node 1000 to initiate a cell selection procedure for a selected PLMN if no cell is found during the determined time period; or initiate a cell selection procedure for a selected PLMN immediately after T1 if the time period is determined to be zero.

In an exemplary embodiment, the terminal node 1000 operates in a low activity RRC state, for example RRC IDLE mode or RRC INACTIVITE mode.

In an exemplary embodiment of the present disclosure, the instructions, when loaded from the memory 1005 and executed by the at least one processor 1003, may cause the terminal node 1000 to, in response to receiving at least one NTN parameter defining a time and/or location relationship between the terminal node and a serving cell, initiate a cell selection procedure to find a cell meeting the cell selection criterion after a time period.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be the T_{service} mentioned above for example. The location parameter may be the D_{distanceThresh} mentioned above for example. Certainly, the NTN parameter may comprise any other parameter that defines the relation between the terminal node and the serving cell.

In an exemplary embodiment, the time period starts from the time instance defined by the service time parameter.

In an exemplary embodiment, the time period starts from the time when a distance between the terminal node and the reference location of the service cell becomes equal to or larger than the distance threshold defined by the location parameter.

In an exemplary embodiment, the time period is a time of 10 seconds.

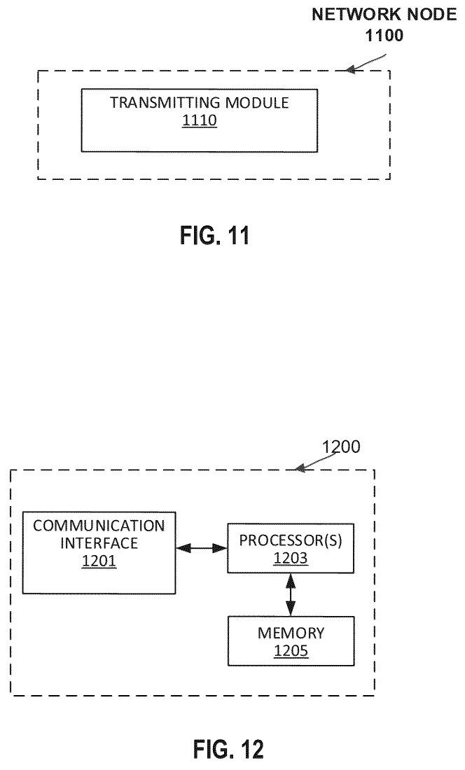

Correspondingly to the method 200 as described above, a network node is provided. FIG. 11 is a block diagram of a network node 1100 according to an exemplary embodiment of the present disclosure.

As shown in FIG. 11, the network node 1100 includes a transmitting module 1110 configured to transmit, to the terminal node, at least one NTN parameter defining a time and/or location relationship between the terminal node and a serving cell and at least one additional parameter. The additional parameter and the NTN parameter will be used by the terminal node in determining a time period after which the terminal node initiates a cell selection procedure to find a cell meeting a cell selection criterion, after determining that the serving cell does not meet the cell selection criterion.

The transmitting module 1110 of the network node 1100 may be configured to perform the actions discussed with FIG. 5 to implement the function of the network node. It will be understood by the skilled in the art, common components in the network node 1100 are omitted in FIG. 11 for not obscuring the idea of the present disclosure. Also, some modules may be distributed in more modules or integrated into fewer modules.

The module 1110 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be the T_{service} mentioned above for example. The location parameter may be the D_{distanceThresh} mentioned above for example. Certainly, the NTN parameter may comprise any other parameter that defines the relation between the terminal node and the serving cell.

In an exemplary embodiment, the at least one additional parameter may comprise a time threshold after which the terminal node initiates the cell selection procedure. The terminal node may determine the time period by taking the time threshold and the time defined by the NTN parameter into account. For example, if the time defined by the NTN parameter is beyond the time threshold, the terminal node may stop the searches and measurements for a suitable cell when the time threshold arrives. As another example, if the time threshold is beyond the time defined by the NTN parameter, the terminal node may stop the searches and measurements for a suitable cell when the time defined by the NTN parameter.

In an exemplary embodiment, the at least one additional parameter may comprises a rule defining a way to consider a DRX cycle length or an eDRX cycle length in determining the time period. In the embodiment, the network node configures the terminal node with the rule to use the DRX cycle length or eDRX cycle length in determining the time period.

FIG. 12 is a block diagram of a network node 1200 according to another embodiment of the present disclosure. The terminal node 1200 in FIG. 12 may perform the method 200 for configuring a terminal node described previously with reference to FIG. 5. Accordingly, some detailed description on the network node 1100 may refer to the corresponding description of the method 200 for configuring a terminal node as previously discussed.

As shown in FIG. 12, the network node 1200 may include at least one controller or processor 1203 including e.g., any suitable Central Processing Unit, CPU, microcontroller, Digital Signal Processor, DSP, etc., capable of executing computer program instructions. The computer program instructions may be stored in a memory 1205. The memory 1205 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary network node 1200 further comprises a communication interface 1201 arranged for communication.

The instructions, when loaded from the memory 1205 and executed by the at least one processor 1203, may cause the network node 1200 to perform the method 200 for configuring a terminal node as previously discussed.

In particular, in an exemplary embodiment of the present disclosure, the instructions, when loaded from the memory 1205 and executed by the at least one processor 1203, may cause the network node 1200 to transmit, to the terminal node, at least one NTN parameter defining a time and/or location relationship between the terminal node and a serving cell and at least one additional parameter. The additional parameter and the NTN parameter will be used by the terminal node in determining a time period after which the terminal node initiates a cell selection procedure to find a cell meeting a cell selection criterion, after determining that the serving cell does not meet the cell selection criterion.

In an exemplary embodiment, the NTN parameter may comprise at least one of a service time parameter that indicates the time when the serving cell is going to stop serving an area it is currently covering and a location parameter that indicates a distance threshold between the terminal node and a reference location of the serving cell. The service time parameter may be the T_{service} mentioned above for example. The location parameter may be the D_{distanceThresh} mentioned above for example. Certainly, the NTN parameter may comprise any other parameter that defines the relation between the terminal node and the serving cell.

In an exemplary embodiment, the at least one additional parameter may comprise a time threshold after which the terminal node initiates the cell selection procedure. The terminal node may determine the time period by taking the time threshold and the time defined by the NTN parameter into account. For example, if the time defined by the NTN parameter is beyond the time threshold, the terminal node may stop the searches and measurements for a suitable cell when the time threshold arrives. As another example, if the time threshold is beyond the time defined by the NTN parameter, the terminal node may stop the searches and measurements for a suitable cell when the time defined by the NTN parameter.

In an exemplary embodiment, the at least one additional parameter may comprises a rule defining a way to consider a DRX cycle length or an eDRX cycle length in determining the time period. In the embodiment, the network node configures the terminal node with the rule to use the DRX cycle length or eDRX cycle length in determining the time period.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1003 causes the terminal node 1000 to perform the actions, e.g., of the procedure described earlier in conjunction with FIG. 4A and FIG. 4B; or code/computer readable instructions, which when executed by the processor 1203 causes the network node 1200 to perform the actions, e.g., of the procedure described earlier in conjunction with FIG. 5.

The computer program product may be configured as a computer program code structured in computer program modules. The computer program modules could essentially perform the actions of the flow illustrated in FIGS. 4A, 4B or FIG. 5.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

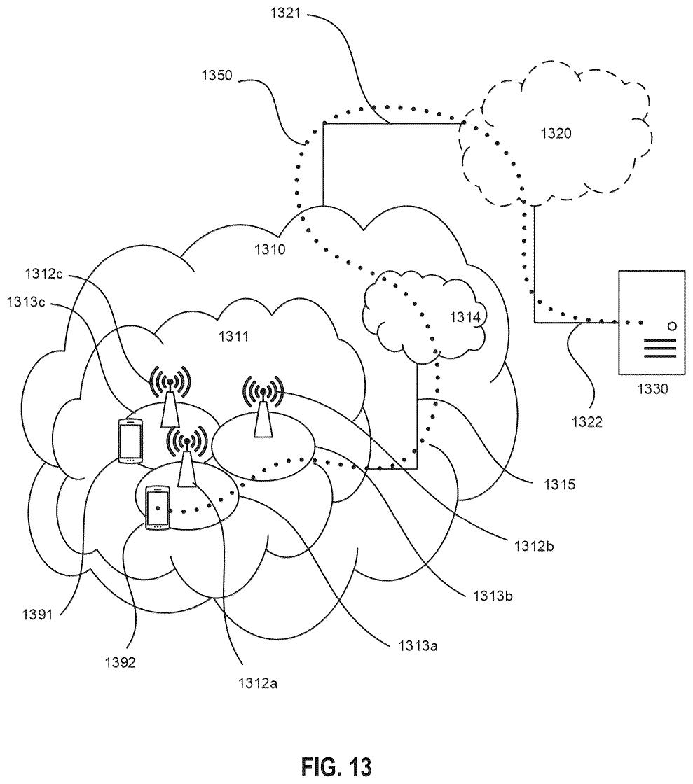

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

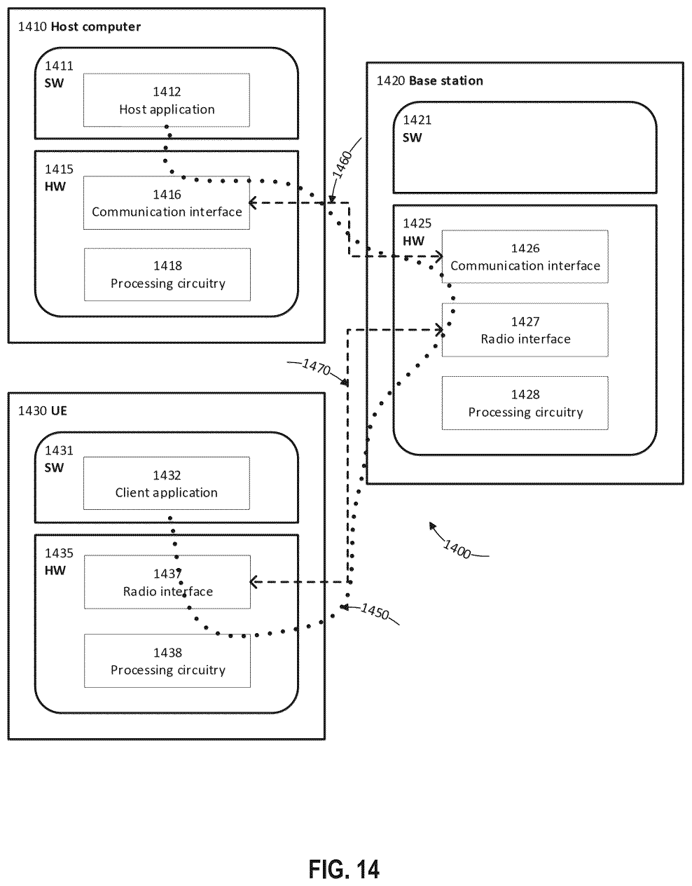

Example implementations, in accordance with an embodiment, of the UE, base station and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312a, 1312b, 1312c and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the radio resource utilization and thereby provide benefits such as such as reduced UE power consumption.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

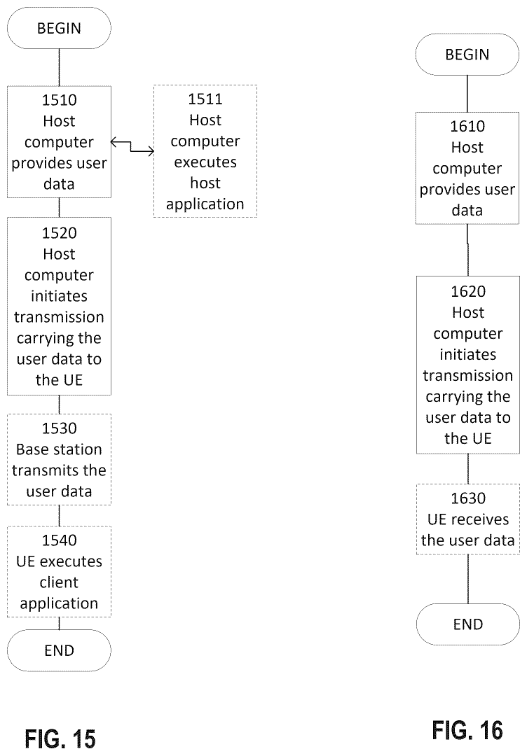

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

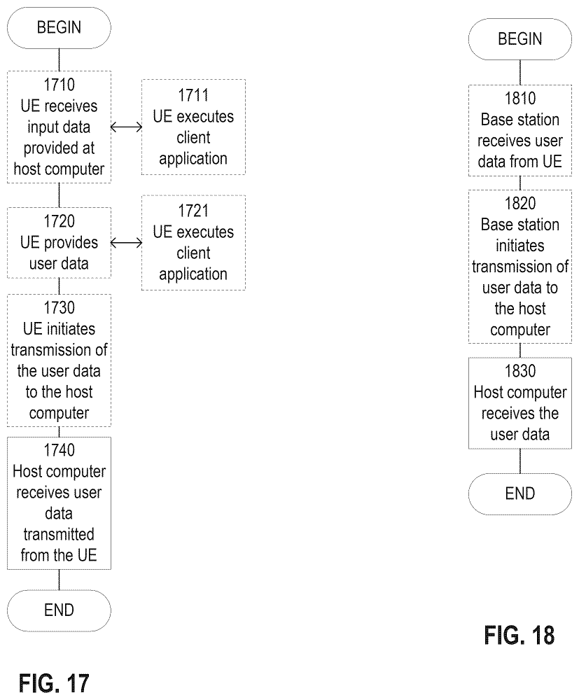

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

### Abbreviation Explanation

3GPP 3rd Generation Partnership Project
5G 5th Generation
5GC 5G Core
5GS 5G System
bps bits per second
BS Base Station
CE Control Element
CHO Conditional Handover
C-RNTI Cell RNTI
CSI-RS Channel State Information Reference Signal
DCI Downlink Control Information
DL Downlink
DMRS Demodulation Reference Signal
DRX Discontinuous Reception
eDRX Extended DRX
eMBB Evolved Mobile Broadband
eMTC Enhanced Machine Type Communication
eNB Evolved NodeB (Radio base station in LTE.)
EPC Evolved Packet Core
EPS Evolved Packet System
GEO Geostationary Earth Orbit
GHz Gigahertz
gNB Radio base station in 5G/NR.
GLONASS Global Navigation Satellite System
GNSS Global Navigation Satellite System
GPS Global Positioning System
GW Gateway
HO Handover
Hz Hertz
ID Identity/Identifier
IMT International Mobile Telecommunications
kHz Kilohertz
LEO Low Earth Orbit
LTE Long Term Evolution
LTE-M LTE-Machine Type Communication
MAC Medium Access Control
MAC CE MAC Control Element
MBB Mobile Broadband
MEO Medium Earth Orbit
MG Measurement Gap
mMTC Massive Machine Type Communication
ms Millisecond
NB-IoT Narrowband Internet of Things
NR New Radio
NTN Non-terrestrial network
PCell Primary Cell
PCI Physical Cell Identity
PDCCH Physical Downlink Control Channel
PDSCH Physical Downlink Shared Channel
PDU Packet Data Unit
PRACH Physical Random Access Channel
PRB Physical Resource Block
PSS Primary Synchronization Signal
PUCCH Physical Uplink Control Channel
PUSCH Physical Uplink Shared Channel
RA Random Access
RAN Radio Access Network
RAT Radio Access Technology
RF Radio Frequency
RMTC RSSI Measurement Timing Configuration
RNTI Radio Network Temporary Identifier
RRC Radio Resource Control
RRM Radio Resource Management
RS Reference Signal
RSRP Reference Signal Received Power
RSRQ Reference Signal Received Quality
RSSI Received Signal Strength Indicator
SFN System Frame Number
SFTD SFN and Frame Timing Difference
SI System Information
SIB System Information Block
SID Study Item Description
SMTC SSB Measurement Timing Configuration
SNR Signal to noise ratio
SRS Sounding Reference Signal
SS Synchronization Signal
SSB Synchronization Signal Block
SSID Service Set Identifier
SSS Secondary Synchronization Signal
TA Timing Advance
TR Technical Report
TS Technical Specification
UCI Uplink Control Information
UE User Equipment
UL Uplink
URLLC Ultra-Reliable Low-Latency Communication
UTC Coordinated Universal Time

1. A method at a terminal node for performing a cell selection procedure in a non-terrestrial network, NTN, system, the method comprising:
determining whether a serving cell meets a cell selection criterion at time instance T1; and
in response to determining that a serving cell does not meet a cell selection criterion at time instance T1, determining a time period after which the terminal node initiates a cell selection procedure to find a cell meeting the cell selection criterion, wherein
the determination of the time period is at least partially based on at least a first obtained parameter and one or more NTN parameters defining a time and/or location relationship between the terminal node and the serving cell.

2. The method of claim 1, wherein
the method further comprises the UE receiving system information, and
during the time period the UE searches for and measures one or more cells using the intra-frequency, inter-frequency, and inter-RAT information indicated in the system information.

3.-5. (canceled)

6. The method of claim 1, wherein the one or more NTN parameters comprise:
a service time parameter that indicates the time when the serving cell is going to stop serving an area it is currently covering, and/or
a location parameter that indicates a distance threshold between the terminal node and a reference location of the serving cell.

7. The method of claim 1, wherein
the one or more NTN parameters comprises a service time parameter, STP, that indicates the time when the serving cell is going to stop serving an area it is currently covering,
the first obtained parameter comprises a time threshold, Thr, and
the duration of the time period is the lower of Thr and (STP−T1).

8. The method of claim 1, wherein
the one or more NTN parameters comprises a service time parameter, STP, that indicates the time when the serving cell is going to stop serving an area it is currently covering, and
if the service time parameter is larger than T1, then the time period starts at T1 and has a duration of D, where D is the first obtained parameter.

9. The method of claim 1, wherein
the one or more NTN parameters comprises a service time parameter, STP, that indicates the time when the serving cell is going to stop serving an area it is currently covering, and
if the service time parameter is less than or equal to T1, then then the time period starts at the service time parameter and has a duration of D, where D is the first obtained parameter.

10. The method of claim 1, wherein
the one or more NTN parameters comprises a service time parameter, STP, that indicates the time when the serving cell is going to stop serving an area it is currently covering,
the first obtained parameter comprises a time threshold, Thr, and
the duration of the time period is zero if STP≤(T1+Thr).

11.-14. (canceled)

15. The method of claim 1, further comprising:
initiating a cell selection procedure for a selected Public Land Mobile Network, PLMN, if no cell is found during the determined time period; or
initiating a cell selection procedure for a selected PLMN immediately after T1 if the time period is determined to be zero.

16. The method of claim 1, wherein the terminal node operates in a low activity RRC state, comprising RRC IDLE mode or RRC INACTIVITE mode.

17. A method at a terminal node for performing a cell selection procedure in a non-terrestrial network, NTN, system, the method comprising:
receiving at least one NTN parameter defining a time and/or location relationship between the terminal node and a serving cell; and
in response to receiving the at least one NTN parameter, initiating a cell selection procedure to find a cell meeting a cell selection criterion after a time period.

18. The method of claim 17, wherein the NTN parameter comprises:
a service time parameter that indicates the time when the serving cell is going to stop serving an area it is currently covering, and/or
a location parameter that indicates a distance threshold between the terminal node and a reference location of the serving cell.

19. The method of claim 17, wherein
the NTN parameter comprises a service time parameter that indicates the time when the serving cell is going to stop serving an area it is currently covering, and
the time period starts at the time instance defined by the service time parameter.

20. The method of claim 17, wherein the time period has a duration of 10 seconds.

21. A method at a network node for configuring a terminal node in a non-terrestrial network, NTN, system, the method comprising:
transmitting, to the terminal node, at least one NTN parameter defining a time and/or location relationship between the terminal node and a serving cell and at least one additional parameter, wherein
the additional parameter and the NTN parameter being used by the terminal node in determining a time period after which the terminal node initiates a cell selection procedure to find a cell meeting a cell selection criterion, after determining that the serving cell does not meet the cell selection criterion.

22. The method of claim 21, wherein the NTN parameter comprises:
a service time parameter that indicates the time when the serving cell is going to stop serving an area it is currently covering, and/or
a location parameter that indicates a distance threshold between the terminal node and a reference location of the serving cell.

23. The method of claim 21, wherein the at least one additional parameter comprises a time threshold after which the terminal node initiates the cell selection procedure.

24. The method of claim 21, wherein the at least one additional parameter comprises a rule defining a way to consider a DRX cycle length or an eDRX cycle length in determining the time period.

25. A terminal node for performing a cell selection procedure in a non-terrestrial network, NTN, system, comprising:
a communication interface arranged for communication,
at least one processor, and
a memory comprising instructions which, when executed by the at least one processor, cause the terminal node to perform a method comprising:
determining whether a serving cell meets a cell selection criterion at time instance T1;
in response to determining that a serving cell does not meet a cell selection criterion at time instance T1, determining a time period after which the terminal node initiates a cell selection procedure to find a cell meeting the cell selection criterion, wherein
the determination of the time period is at least partially based on at least one obtained parameter and one or more NTN parameters defining a time and/or location relationship between the terminal node and the serving cell.

26. (canceled)

27. A terminal node for performing a cell selection procedure in a non-terrestrial network, NTN, system, comprising:
a communication interface arranged for communication,
at least one processor, and
a memory comprising instructions which, when executed by the at least one processor, cause the terminal node to perform a method comprising:
in response to receiving at least one NTN parameter defining a time and/or location relationship between the terminal node and a serving cell, initiating a cell selection procedure to find a cell meeting a cell selection criterion after a time period.

28.-29. (canceled)

30. A network node for configuring a terminal node in a non-terrestrial network, NTN, system comprising:
a communication interface arranged for communication,
at least one processor, and
a memory comprising instructions which, when executed by the at least one processor, cause the network node to perform a method comprising:
transmitting, to the terminal node, at least one NTN parameter defining a time and/or location relationship between the terminal node and a serving cell and at least one additional parameter, wherein
the additional parameter and the NTN parameter being used by the terminal node in determining a time period after which the terminal node initiates a cell selection procedure to find a cell meeting a cell selection criterion, after determining that the serving cell does not meet the cell selection criterion.

31.-32. (canceled)
